(19) United States
(12) Patent Application Publication
(10) Pub. No.: US 2025/0258375 A1
(43) Pub. Date: Aug. 14, 2025

(54) EYEWEAR DISPLAY HAVING A WAVEGUIDE WITH ADJUSTABLE REFLECTORS

(71) Applicant: GOOGLE LLC, Mountain View, CA (US)

(72) Inventors: Alexander Koshelev, San Jose, CA (US); Oleg Yaroshchuk, Mountain View, CA (US); Ravi Kumar Komanduri, Mountain View, CA (US); Christophe Peroz, Zurich (CH)

(21) Appl. No.: 18/436,374

(22) Filed: Feb. 8, 2024

(51) Int. Cl. G02B 27/01; G02F 1/13

(52) U.S. Cl. CPC G02B 27/0172; G02B 27/0179; G02F 1/1326; G02B 2027/014; G02B 2027/0178; G02B 2027/0187

(57) ABSTRACT

An eyewear display includes a waveguide incorporated into at least one of the lenses of the eyewear display. The waveguide includes a first set of adjustable reflectors, and each adjustable reflector of the first set of adjustable reflectors is switchable between a first state in which the adjustable reflector is transparent and a second state in which the adjustable reflector reflects a portion of light incident thereon. The eyewear display also includes a controller to send a control signal to a subset of the first set of adjustable reflectors to control the subset of the first set of adjustable reflectors to operate in the first state or the second state.

### BACKGROUND

Eyewear displays employ optical combiners to allow a user to view virtual content (e.g., text, images, or video content) superimposed over the user's environment, creating what is known as augmented reality (AR) or mixed reality (MR). The optical combiner combines light from multiple sources such as environmental light from outside of the eyewear display and display light from an image source of the eyewear display. The image source, such as a laser projector or a micro-light emitting diode (micro-LED) panel, transmits the display light to the user via a waveguide in the optical combiner. The display light beams from the image source are coupled into the waveguide by an incoupler which can be formed on or disposed within the waveguide. Once the display light beams have been coupled into the waveguide, the incoupled display light beams are “guided” through the waveguide, typically by multiple instances of total internal reflection (TIR), and then directed out of the waveguide by an outcoupler, which can also be formed on or within the waveguide. The outcoupled display light beams overlap at an eye relief distance from the waveguide forming an exit pupil within which a virtual image generated by the image source can be viewed by the user. In addition, the waveguide can include an exit pupil expander positioned between the incoupler and the outcoupler to increase the size of the exit pupil within which the user can view the virtual image.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of an eyewear display in accordance with some embodiments.

FIG. 2 shows an example of a projection system in the eyewear display of FIG. 1 in accordance with some embodiments.

FIG. 3 shows light propagation from an image source to a user of an eyewear display, such as that of FIGS. 1 and 2, in accordance with some embodiments

FIG. 4 shows a plan view illustrating an example of the propagation of light within a waveguide with adjustable reflectors, such as the waveguide of FIGS. 2 and 3, and a cross-section of a set of adjustable reflectors, in accordance with some embodiments.

FIGS. 5 and 6 show two modes of a waveguide, such as the waveguide of FIG. 4, having different subsets of adjustable reflectors activated to direct light to different eyeboxes, in accordance with some embodiments.

FIG. 7 shows a cross section view of an optical combiner stack, such as one corresponding to the optical combiner of FIG. 3, in accordance with some embodiments.

FIG. 8 shows plan views of a waveguide and a dimming module layer of the optical combiner stack of FIG. 7 in accordance with some embodiments.

FIG. 9 shows an example of a switchable filter embedded in a waveguide between the exit pupil expander and the outcoupler in accordance with some embodiments.

FIG. 10 shows another embodiment of a switchable filter embedded in a waveguide between the exit pupil expander and the outcoupler in accordance with some embodiments.

FIG. 11 shows an example of switching an adjustable reflector, such as those described above in FIGS. 1-10, from a first state to a second state in accordance with some embodiments

FIG. 12 shows an example of a CLC planar structure of an adjustable reflector in accordance with some embodiments.

FIG. 13 shows an example method of fabricating an adjustable reflector in accordance with some embodiments.

FIGS. 14-16 show fabrication processes for forming a reflective waveguide with adjustable reflectors in accordance with some embodiments.

FIG. 17 shows a first example of an adjustable reflector with one or more passive elements in accordance with some embodiments.

FIG. 18 shows a second example of an adjustable reflector with one or more passive elements in accordance with some embodiments.

FIG. 19 shows an example of a flowchart describing a method to adjust the reflectivity of the adjustable reflectors in a reflective waveguide of an eyewear display in accordance with some embodiments.

### DETAILED DESCRIPTION

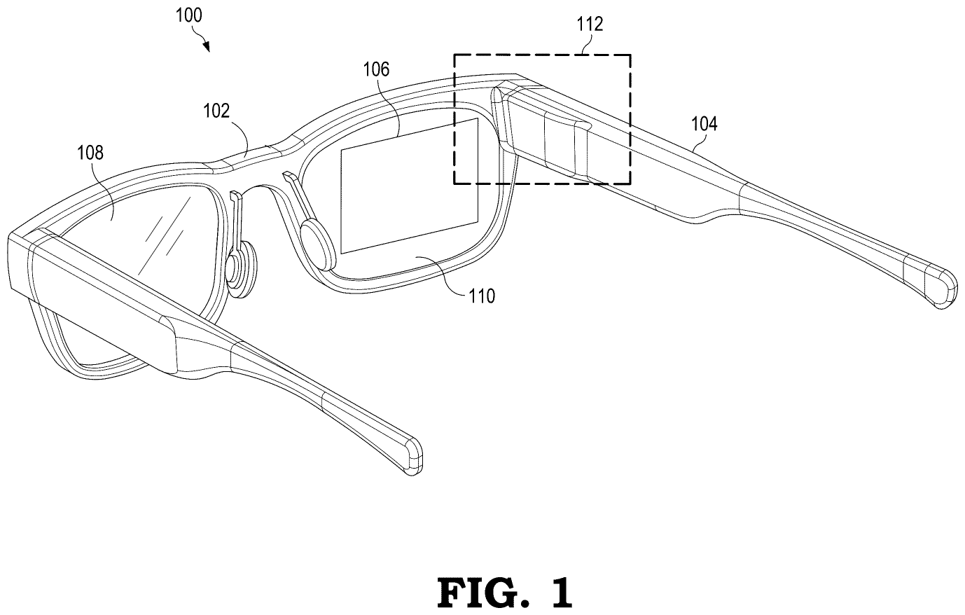

Pupil replicating waveguides, such as diffractive, reflective, and holographic waveguides, are widely used in optical combiners due to their ability to make virtual content visible within a large eyebox of the eyewear display. An eyewear display's eyebox refers to the volume of space within which the virtual content generated by the eyewear display is fully viewable. Typically, the incoupler of a pupil replicating waveguide receives a small input pupil (e.g., about 1 to 5 mm in diameter) from an image source and the pupil replicating waveguide creates exit pupil replicas of the input pupil to fill a much larger eyebox (e.g., typically in the scale of 8×8 millimeters (mm) to 20×20 mm) by outcoupling light over a larger (relative to the incoupler) outcoupler area. The small size of the input pupil allows for compact image sources to facilitate implementation in wearable devices such as eyewear displays, and the larger size of the eyebox accounts for uncertainty in a potential user's eye pupil position due to different facial geometries (e.g., different interpupillary distances, IPDs) and different eye orientations (e.g., whether the user is looking straight ahead, up, down, or to a side). Conventional waveguides are susceptible to reduced luminance attributed to the expansion of light from a small input pupil to a much larger projection area and reduced efficiency since a large portion of the outcoupled light is not viewed. To create a larger eyebox, conventional waveguides typically include light reflecting structures such as arrays of reflective facets or louver mirrors that occupy large areas of the waveguide. Increasing the portion of the waveguide occupied by these light reflecting structures generally decreases the efficiency of the waveguide and the uniformity of the light projected within the eyebox as well as increasing the generation of visual artifacts such as image ghosts and “rainbow”-like artifacts. FIGS. 1-19 provide an eyewear display that includes a waveguide with adjustable reflectors that can be switched between different states (e.g., a transparent state and a reflective state) to selectively modify which areas of the waveguide are activated for delivering virtual content to the user. This increases the efficiency of the waveguide and improves the image quality.

To illustrate, in some embodiments, an eyewear display includes a waveguide and a controller. The waveguide includes a first set of adjustable reflectors. In some cases, the waveguide also includes a second set of adjustable reflectors. For example, the first set of adjustable reflectors is located in an exit pupil expander and the second set of adjustable reflectors is located in an outcoupler. In other embodiments, at least one of the first set and the second set of adjustable reflectors is positioned between the exit pupil expander and the outcoupler. In any case, each adjustable reflector of the first set or the second set of adjustable reflectors is switchable between a first state in which the adjustable reflector is relatively transparent (e.g., transmits over 95% of the light incident thereon) and at least one second state in which the adjustable reflector is relatively reflective (e.g., reflects 5% or more of the light incident thereon). The controller is configured to send a first control signal to a first subset of the first set of adjustable reflectors and (if applicable) a second control signal to a second subset of the second set of adjustable reflectors to control the respective subset of adjustable reflectors to operate in the first state or the second state. For example, the controller generates the first or second control signals based on eye information data received from an eye tracking system of the eyewear display that indicates at least one of a position or an orientation of an eye of the user of the eyewear display. In this manner, the eyewear display selectively activates a subset of adjustable reflectors in the waveguide to adjust the eyebox of the eyewear display based on a detected eye pupil position while deactivating the adjustable reflectors that are not needed. This improves the efficiency of the waveguide and the uniformity of the image delivered to the user while reducing the appearance of unwanted visual artifacts.

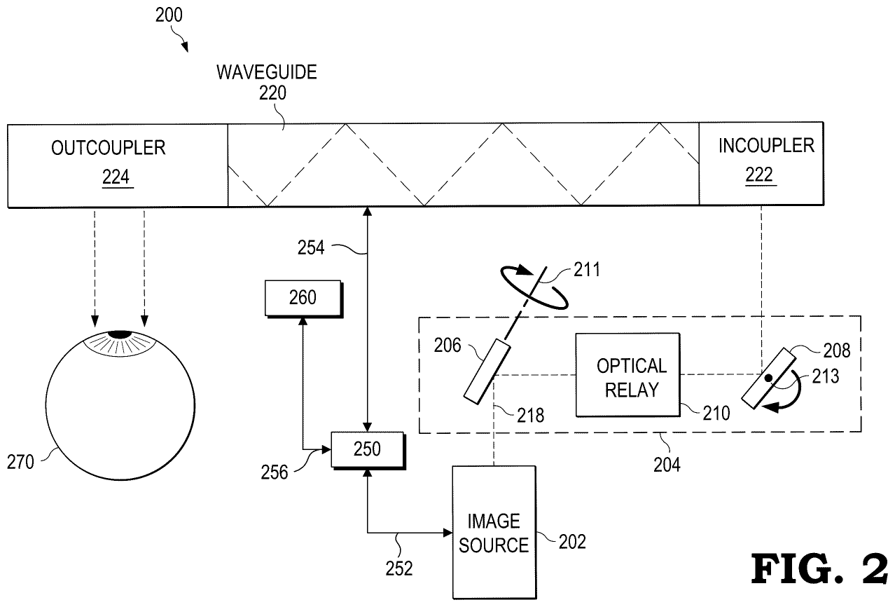

FIG. 1 illustrates an example eyewear display 100 in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images towards the eye of a user, such that the user perceives the projected images as being displayed in a field of view (FOV) area 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images towards the eye of the user, such as an image source, a controller, a light engine assembly (LEA), and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in region 112 of the support structure 102. It should be noted that while an example form factor is depicted, it will be appreciated that in other embodiments the eyewear display 100 may have a different shape and appearance from the eyeglasses frame depicted in FIG. 1.

In some embodiments, one or both of the lens elements 108, 110 are used by the eyewear display 100 to provide a mixed reality (MR) or an augmented reality (AR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from an image source in the eyewear display 100. For example, light used to form a perceptible image or series of images may be projected by the image source of the eyewear display 100 onto the eye of the user via a series of optical elements, such as a waveguide formed at least partially in the corresponding lens element, a LEA including one or more light filters, lenses, scan mirrors, optical relays, prisms, or the like, and a patterned layer formed on the front surface of the image source. In some embodiments, the image source is configured to emit light having a plurality of wavelength ranges, e.g., red light, green light, and blue light (collectively referred to as RGB light). The light passes through the patterned layer to the LEA, which propagates the light towards an incoupler of the waveguide. The incoupler of the waveguide receives this light and incouples it into the waveguide. One or both of the lens elements 108, 110 thus includes at least a portion of a waveguide that routes display light received by the incoupler of the waveguide to an outcoupler of the waveguide, which outputs the display light towards an eye of a user of the eyewear display 100. The display light is modulated and projected onto the eye of the user such that the user perceives the display light as an image in FOV area 106. In addition, in some embodiments, each of the lens elements 108, 110 is sufficiently transparent to allow a user to see through the lens elements to provide a field of view of the user's real-world environment such that the image appears superimposed over at least a portion of the real-world environment.

In some embodiments, the image source is a digital light processing-based projector, a scanning laser projector, a liquid crystal on silicon (LCoS) light engine, or any combination of a modulative light source such as a laser or one or more light-emitting diodes (LEDs) or organic light-emitting diodes (OLEDs) (e.g., a micro-LED display panel or the like) located in region 112. In some embodiments, the image source is configured to emit RGB light. In some embodiments, the light engine includes multiple laser diodes (e.g., a red laser diode, a green laser diode, and/or a blue laser diode) and at least one scan mirror (e.g., two one-dimensional scan mirrors, which may be microelectromechanical system (MEMS)-based or piezo-based). The image source is communicatively coupled to the controller (not shown) and a non-transitory processor-readable storage medium or memory storing processor-executable instructions and other data that, when executed by the controller, cause the controller to control the operation of the image source. In some embodiments, the controller controls a scan area size and scan area location for the image source and is communicatively coupled to the image source that generates virtual content to be displayed at the eyewear display 100. In some embodiments, the image source emits light over a variable area, designated the FOV area 106, of the eyewear display 100. The variable area corresponds to the size of the FOV area 106, and the variable area location corresponds to a region of one of the lens elements 108, 110 at which the FOV area 106 is visible to the user.

As previously mentioned, a waveguide is integrated into one or both of lens elements 108, 110. In some configurations, the waveguide includes a single waveguide substrate and in other configurations, the waveguide includes multiple waveguide substrates stacked on top of one another (referred to as a waveguide stack). In some embodiments, the incoupler of the waveguide includes features to increase the incoupling of light into the waveguide and an outcoupler to increase the outcoupling of the light to the user via FOV area 106. In some embodiments, the waveguide includes at least a first set of adjustable reflectors. Each adjustable reflector of the first set of adjustable reflectors is switchable between a first state in which the adjustable reflector is transparent and a second state in which the adjustable reflector reflects a portion of light incident thereon. The controller of the eyewear display 100 is configured to send a control signal to the first set of adjustable reflectors to control a subset of the first set of adjustable reflectors to operate in the first state or in the second state, and thus modify the FOV area 106 and the associated eyebox of the eyewear display 100. As used herein, a “subset” of a first set (or, similarly, of a second set) of adjustable reflectors includes one or more of the adjustable reflectors of the first set (or of the second set). For example, in some cases, a subset includes as few as one of the adjustable reflectors, and in other cases, a subset includes all of the adjustable reflectors.

FIG. 2 illustrates a diagram of a projection system 200 that projects images onto the eye 216 of a user in accordance with various embodiments. The projection system 200, which may be implemented in the eyewear display 100 in FIG. 1, includes one or more of an image source 202, a light engine assembly (LEA) 204, and/or a waveguide 220. In this example, the LEA 204 includes a first scan mirror 206, a second scan mirror 208, and an optical relay 210. The waveguide 220 includes one or more incouplers 222 and one or more outcouplers 224, with the one or more outcouplers 224 being optically aligned with an eye 270 of a user. For example, the one or more outcouplers 224 substantially overlap with the FOV area 106 shown in FIG. 1.

The image source 202 includes one or more light sources configured to generate and project display light 218 (e.g., visible light such as RGB light and, in some embodiments, non-visible light such as infrared light). In some embodiments, the image source 202 is coupled to a controller 250 or other driver, which controls the timing of emission of display light from the light sources of the image source 202 in accordance with instructions received by the controller or driver from a computer processor coupled thereto to modulate the display light 218 to be perceived as images when output to the retina of an eye 270 of a user. The controller 250 includes hardware, software, or a combination thereof to perform the functions recited herein. During operation of the projection system 200, one or more beams of display light 218 are output by the light source(s) of the image source 202 and then directed into the waveguide 220 before being directed to the eye 270 of the user. The image source 202 modulates the respective intensities of the light beams so that the combined light reflects a series of pixels of an image, with the particular intensity of each light beam at any given point in time contributing to the amount of corresponding color content and brightness in the pixel being represented by the combined light at that time.

In the illustrated embodiment, the projection system 200 includes an eye tracking component 260 coupled to the controller 250. The eye tracking component 260 includes hardware (such as sensors), software, or a combination thereof to track the position and orientation of the eye 270 of the user and sends this information to the controller 250 via interface 256. In some embodiments, based on the eye position information received from the eye tracking component 260, the controller 250 sends a control signal to the image source 202 via interface 252 to modify operation of the image source 202. For example, in some embodiments, the controller 250 sends a control signal to the image source 202 to modify one or more of an intensity of light emitted from the image source, a direction of light emitted from the image source, or the like. In addition, the controller 250 is also coupled to the waveguide 220 via interface 254 to send one or more control signals to at least a first set of adjustable reflectors in the waveguide 220 as discussed herein. For example, in some embodiments, based on the information obtained from eye tracking component 260, the controller 250 transmits a control signal to the waveguide 220 via interface 254 to activate or deactivate a subset of the first set of adjustable reflectors in the waveguide 220.

In some embodiments, the image source 202 projects the display light 218 to the LEA 204. In some embodiments, one or both of the scan mirrors 206 and 208 in the LEA 204 are MEMS mirrors that are driven by respective actuation voltages to oscillate during active operation of the projection system 200, causing the scan mirrors 206 and 208 to scan the light 218. Oscillation of the scan mirror 206 causes light 218 output by the light engine 202 to be scanned through the optical relay 210 and across a surface of the second scan mirror 208. The second scan mirror 208 scans the light 218 received from the scan mirror 206 toward the incoupler 222 of the waveguide 220. In some embodiments, the scan mirror 206 oscillates along a first scanning axis 211, such that the light 218 is scanned in only one dimension (i.e., in a line) across the surface of the second scan mirror 208. In some embodiments, the scan mirror 208 oscillates or otherwise rotates along a second scanning axis 213. In some embodiments, the first scanning axis 211 is perpendicular to the second scanning axis 213.

In some embodiments, the optical relay 210 is a line-scan optical relay that receives the light 218 scanned in a first dimension by the first scan mirror 206 (e.g., the first dimension corresponding to the small dimension of the incoupler 222), routes the light 218 to the second scan mirror 208, and introduces a convergence to the light 218 in the first dimension to an exit pupil beyond the second scan mirror 208. Herein, an “exit pupil” in an optical system refers to the location along the optical path where beams of light intersect. For example, the possible optical paths of the light 218, following reflection by the first scan mirror 206, are initially spread along the first scanning axis, but later these paths intersect at an exit pupil beyond the second scan mirror 208 due to convergence introduced by the optical relay 210. For example, the width (i.e., smallest dimension) of a given exit pupil approximately corresponds to the diameter of the light corresponding to that exit pupil. Accordingly, the exit pupil can be considered a “virtual aperture.” According to various embodiments, the optical relay 210 includes one or more collimation lenses that shape and focus the light 218 on the second scan mirror 208 or includes a molded reflective relay that includes two or more spherical, aspheric, parabolic, and/or freeform lenses that shape and direct the light 218 onto the second scan mirror 208. The second scan mirror 208 receives the light 218 and scans the light 218 in a second dimension, the second dimension corresponding to the long dimension of the incoupler 222 of the waveguide 220. In some embodiments, the second scan mirror 208 causes the exit pupil of the light 218 to be swept along a line along the second dimension.

The incoupler 222 is configured to receive the display light 218 and direct the display light 218 into the waveguide 220. The term “waveguide,” as used herein, is understood to mean a combiner using one or more of total internal reflection (TIR), specialized filters, or reflective surfaces, to transfer light from an incoupler (such as incoupler 222) to an outcoupler (such as the outcoupler 224). In some display applications, the light is a collimated image, and the waveguide 220 transfers and replicates the collimated image to the eye. In general, the terms “incoupler,” “outcoupler,” and “exit pupil expander” will be understood to refer to any type of optical grating structure, including, but not limited to, adjustable reflectors are described herein, reflective facets, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the display light 218 received at the incoupler 222 is propagated to the outcoupler 224 via the waveguide 220 using TIR. A portion of the display light 218 is then output to the eye 270 of a user via the outcoupler(s) 224. Also, in some embodiments, one or more exit pupil expanders (not shown), such as a fold grating, are arranged in an intermediate stage between incoupler 222 and outcoupler 224 to receive light that is coupled into waveguide 220 by the incoupler 222, expand the light in one dimension, and redirect the light towards the outcoupler 224. As described above, in some embodiments the waveguide 220 is implemented in an optical combiner as part of an eyeglass lens, such as the lens element 108, 110 of FIG. 1 having an eyeglass form factor and employing projection system 200.

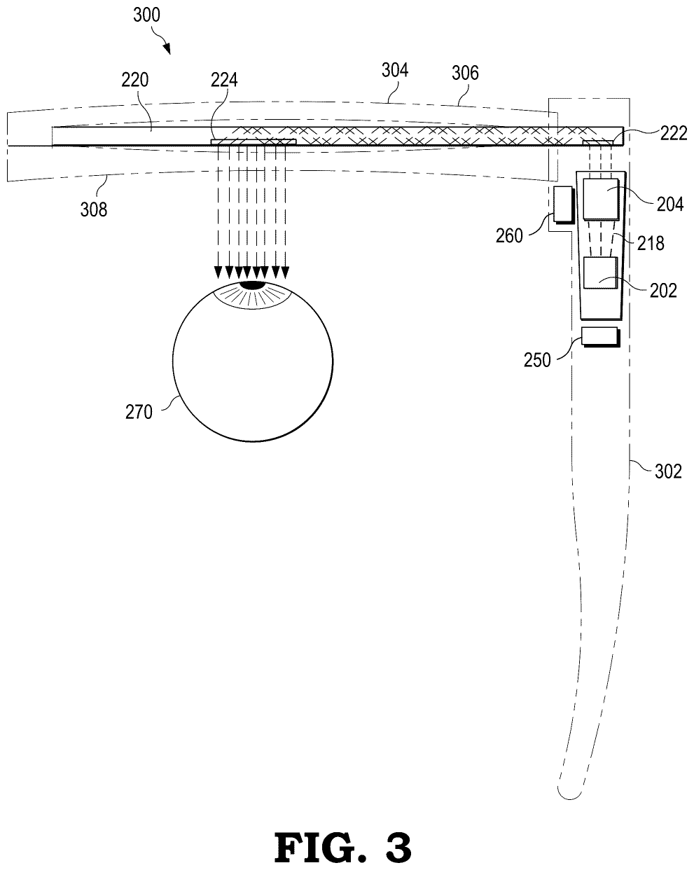

FIG. 3 illustrates a portion of an eyewear display 300 in accordance with various embodiments. In some embodiments, the eyewear display 300 represents the display 100 of FIG. 1 and includes the components of the projection system 200 of FIG. 2. The image source 202, the LEA 204, the incoupler 222, the controller 250, the eye tracking component 260, and a portion of the waveguide 220 are included in an arm 302 of the eyewear display 300, in the present example.

The eyewear display 300 includes an optical combiner lens 304, which includes a first lens 306, a second lens 308, and the waveguide 220, with the waveguide 220 disposed between the first lens 306 and the second lens 308. Light exiting through the outcoupler 214 travels through the second lens 308 (which corresponds to, for example, the lens element 110 of the eyewear display 100). In use, the light exiting second lens 308 enters the pupil of an eye 270 of a user wearing the eyewear display 300, causing the user to perceive a displayed image carried by the laser light output by the image source 202. In some embodiments, the optical combiner lens 304 is substantially transparent, such that light from real-world scenes corresponding to the environment around the eyewear display 300 passes through the first lens 306, the second lens 308, and the waveguide 220 to the eye 270 of the user. In this way, images or other graphical content output by the projection system 200 are combined (e.g., overlayed) with real-world images of the user's environment when projected onto the eye 270 of the user to provide an AR experience to the user. The eyebox of eyewear display 300 corresponds to the region (or volume) in which the eye 270 of the user can perceive images associated with light projected from image source 202.

In some embodiments, additional optical elements are included in any of the optical paths between the image source 202 and the incoupler 222, in between the incoupler 222 and the outcoupler 224, and/or in between the outcoupler 224 and the eye 270 of the user (e.g., in order to shape the display light from image source 202 for viewing by the eye 270 of the user). As an example, the waveguide 220 includes at least a first set of adjustable reflectors (or reflective facets) that are switchable between a first state in which the adjustable reflector is transparent and a second state in which the adjustable reflector reflects a portion of the light incident thereon. In addition, according to some embodiments, the controller 250 is configured to selectively switch (also referred to as activate) a subset of adjustable reflectors from the first state to the second state or vice versa. For example, in some embodiments, the controller 250 controls which of the adjustable reflectors operate in the first state or in the second state based on eye tracking information obtained from eye tracking component 260. By selectively activating a subset of adjustable reflectors of the first set of adjustable reflectors in the waveguide 220, eyewear display 300 is configured to selectively modify the eyebox of the eyewear display based on a detected position or orientation of the eye 270 of a user.

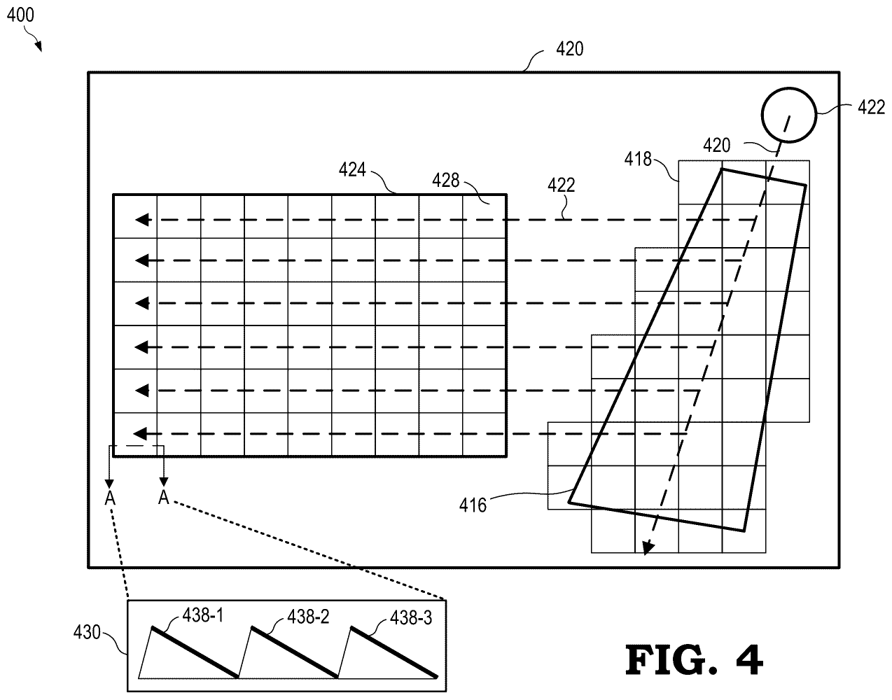

FIG. 4 shows a plan view 400 of an example of light propagation within a waveguide 420 having adjustable reflectors, such as one corresponding to the waveguide 220 of FIGS. 2 and 3, in accordance with some embodiments. As shown, light is initially received by the waveguide 420 via incoupler 422, directed as light 420 into an exit pupil expander (EPE) 416, and then routed as light 420 to the outcoupler 424 to be output from the waveguide 420 toward the eye of the user (e.g., the light is reflected by the outcoupler 420 in a direction out of the page). In this manner, the exit pupil expander 416 expands one or more dimensions of the eyebox of an eyewear display that includes the projection system 200 (e.g., with respect to what the dimensions of the eyebox of the eyewear display would be without the exit pupil expander 416).

In some embodiments, at least one of the exit pupil expander 416 and the outcoupler 424 include a set of adjustable reflectors. For example, referring to exit pupil expander 416, the exit pupil expander 416 includes an adjustable reflector array having a plurality of reflector regions 418 (one labeled for clarity). Each reflector region 418 includes one or more adjustable reflectors that can be switched between a first state in which the one or more adjustable reflectors are transparent and a second state in which the one or more adjustable reflectors reflect a portion (e.g., between about 3% and 50%) of light incident thereon. Similarly, the outcoupler 424 also includes an adjustable reflector array having a plurality of reflector regions 428 (one labeled for clarity). Each reflector region 428 includes one or more adjustable reflectors that can be switched between a first state in which the one or more adjustable reflectors are transparent and a second state in which the one or more adjustable reflectors reflect a portion (e.g., between about 3% and 50%) of light incident thereon.

In some embodiments, the adjustable reflectors of the exit pupil expander 416 and of the outcoupler 424 are composed of active cholesteric liquid crystals arranged between two electrodes. The reflectivity of the adjustable reflectors can be switched off or on, i.e., between a first state where the adjustable reflector is transparent and a second state where the adjustable reflector reflects at least a portion of the light incident thereon, by a controller (such as the controller 250 of FIGS. 2 and 3) transmitting a voltage control signal to the electrodes. In some embodiments, the adjustable reflector being switched “on” refers to the adjustable reflector being activated, and the adjustable reflector being switched “off” refers to the adjustable reflector being deactivated or placed in the transparent state. In some cases, in the “on” state, the adjustable reflector reflects a particular amount of light incident thereon, e.g., between 3%-50%, depending on the location of the adjustable reflector within the waveguide. For example, in some embodiments, the adjustable reflectors in the exit pupil expander 416 that are positioned closer to the incoupler 422 reflect a lower portion (e.g., closer to 3%) of light incident thereon than the adjustable reflectors in the exit pupil expander 416 that are farther away from the incoupler 422 which reflect a higher portion (e.g., closer to 50%) of light incident thereon. Similarly, in some embodiments, the adjustable reflectors in the outcoupler 424 positioned closer to the exit pupil expander 416 reflect a lower portion of light incident thereon than the adjustable reflectors in the outcoupler 424 that are farther away from the exit pupil expander 416. In this manner, the outcoupler 424 and the exit pupil expander 416 are designed to direct display light from an image source such that the light outcoupled by the waveguide 420 has a more uniform luminance. Thus, each of the regions 418 of the exit pupil expander 416 and the regions 428 of the outcoupler 424 can be turned “on” (i.e., activated, or switched to a second state of higher reflectivity) or turned “off (i.e., deactivated, or switched to a first state in which the respective region is transparent).

FIG. 4 also shows a cross section view 430 taken along line A-A to illustrate an arrangement of adjustable reflectors 438-1, 438-2, 438-3 in a reflector region 428 of the outcoupler 424. In the illustrated embodiment, three adjustable reflectors 438-1, 438-2, 438-3 are shown. In other embodiments, a different number of adjustable reflectors 438 are included in each region 428 (e.g., one adjustable reflector, two adjustable reflectors, four or more adjustable reflectors). In some embodiments, each one of the adjustable reflectors 438-1, 438-2, 438-3 includes an active cholesteric liquid crystal layer arranged between two electrodes. The adjustable reflectors 438-1, 438-2, 438-3 are configured to be switched between a first state in which the active cholesteric liquid crystal layer is transparent and a second state in which the active cholesteric liquid crystal layer reflects a portion of light incident thereon based on a voltage control signal applied at the electrodes. Thus, by controlling the adjustable reflectors 438-1, 438-2, 438-3 to switch between the first state and the second state, different regions 428 of the outcoupler 424 (and similarly, different regions 418 of the exit pupil expander 416) can be activated for modifying an eyebox of an eyewear display based on a detected pupil position. This improves waveguide efficiency and reduces the generation of visual artifacts.

In some embodiments, the waveguide 420 is configured to operate in one or more modes depending on the frame rate (or ability to switch between the first and the second state) of the adjustable reflectors and depending on the sensors (such as those corresponding to the eye tracking component described in FIGS. 1-3) of the eyewear display housing the waveguide 420.

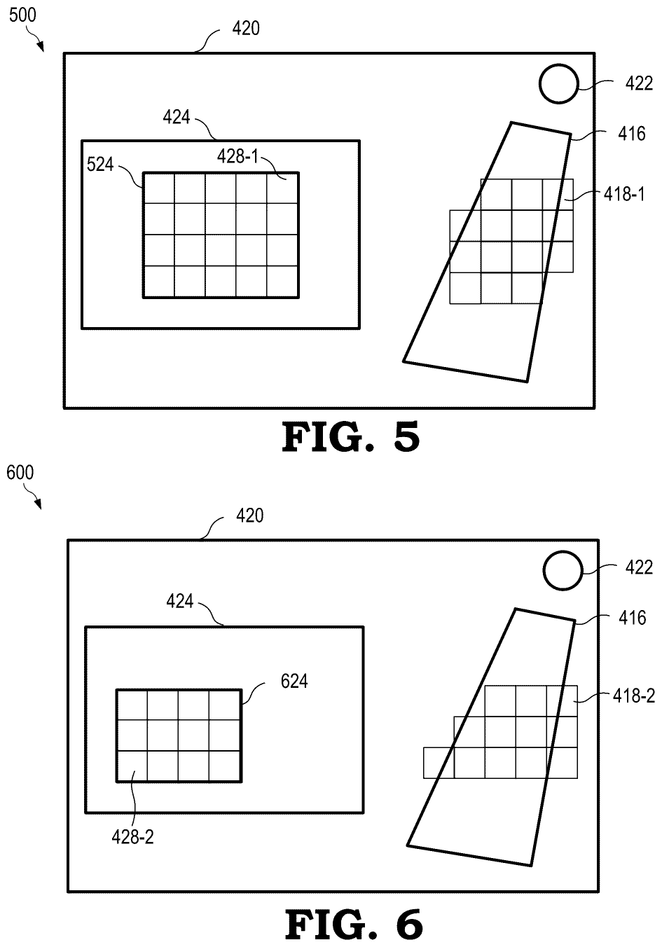

For example, one mode of operation is a standby mode in which all the adjustable reflectors are turned “off” (i.e., switched to the transparent state). In this case, the subset of the adjustable reflectors that are turned “off” includes the entire set of adjustable reflectors. Thus, when the eyewear display is being worn but no virtual content is being generated by the image source, the adjustable reflectors are in the transparent state to reduce or eliminate the generation of see-through or “rainbow”-like artifacts attributed to reflection of ambient light on the reflective structure of the waveguide. Once the eyewear display exits the standby mode (e.g., due to user input or a notification appearing), at least some of the adjustable reflectors are turned “on” (i.e., turned to the state in which the adjustable reflector reflects a portion of the light incident thereon) to display virtual content to the user. In another example, another mode of operation includes activating a small subset of the adjustable reflectors in the exit pupil expander and the outcoupler to support a smaller FOV area (e.g., 5% to 20% of the nominal FOV area). This smaller FOV area can display the status of the eyewear glasses, such as battery power, mobile signal, or the like, at a certain position within the eyebox. For example, referring to FIG. 1, the status of the eyewear glasses can be displayed at the top right corner of the FOV area 106, and thus, the adjustable reflectors of the waveguide corresponding to the top right corner of FOV area 106 are activated while the adjustable reflectors associated with the rest of the FOV area 106 are deactivated. Other modes of operation include activating the adjustable reflectors based on a user's eye position (e.g., based on a user's IPD), eye orientation/pupil position (e.g., based on whether the user is looking up or down or to a side), or based on the type of content provided (e.g., activating a larger amount of the adjustable reflectors based on larger virtual images). FIGS. 5-6 illustrate additional examples of different modes for activating subsets of adjustable reflectors in a waveguide.

FIGS. 5-6 show examples of the waveguide 420 of FIG. 4 with different activated subsets of adjustable reflectors in the exit pupil expander 416 and the outcoupler 424, in accordance with some embodiments. The activation of the respective subsets of adjustable reflectors is controlled by a controller (such as controller 250 of FIGS. 2 and 3) which generates control signals based on information obtained from an eye tracking system (such as eye tracking component 260 of FIGS. 2 and 3). By activating different subsets of the adjustable reflectors in the waveguide 420, the eyewear display housing the waveguide 420 is able to modify the FOV area, and thus, the corresponding eyebox, in which the virtual content can be observed. This increases the efficiency of the projection system of the eyewear display and improves the image quality.

Referring to FIG. 5, in some embodiments, the waveguide 420 is configured in a first mode 500 to activate particular subsets of the adjustable reflectors in the exit pupil expander 416 and in the outcoupler 424 to support a smaller eyebox (and corresponding FOV area) based on a user's facial geometry, detected pupil position, or type of virtual content to be displayed by the eyewear display housing the waveguide 420. For example, the waveguide 420 activates a first subset 418-1 (one labeled for clarity) of the adjustable reflectors in the exit pupil expander 416 and a second subset 428-1 (one labeled for clarity) of the adjustable reflectors in the outcoupler 424 so that the active area of the outcoupler is reduced from an area corresponding to the entire outcoupler 424 to a reduced area 524. In the illustrated embodiment, the first subset 428-1 of adjustable reflectors activated in the outcoupler 424 is less than all of the adjustable reflectors 428 associated with the outcoupler 424 of the waveguide illustrated in FIG. 4. Similarly, the second subset 418-1 of adjustable reflectors activated in the exit pupil expander 416 is less than all of the adjustable reflectors 418 associated with the exit pupil expander 416 of the waveguide illustrated in FIG. 4. The other adjustable reflectors not included in either of the subsets are deactivated or turned off (i.e., placed in the transparent state). In this manner, the waveguide 420 turns off (deactivates) a subset of the adjustable reflectors in both the exit pupil expander 416 and the outcoupler 424 to support a smaller eyebox that is better tailored to the user's pupil distance, pupil position, or type of virtual content that is being presented.

Referring to FIG. 6, in some embodiments, the waveguide 420 is configured to activate different subsets (compared to FIG. 5) of the adjustable reflectors in the exit pupil expander 416 and in the outcoupler 424 to support a different eyebox (and corresponding FOV area) based on a user's facial geometry, pupil position, or type of virtual content to be displayed by the eyewear display housing the waveguide 420. For example, the waveguide 420 activates a first subset 418-2 (one labeled for clarity) of the adjustable reflectors in the exit pupil expander 416 and a second subset 428-2 (one labeled for clarity) of the adjustable reflectors in the outcoupler 424 so that the active area of the outcoupler is reduced from an area corresponding to the entire outcoupler 424 to a reduced area 624. Compared to the embodiment shown in FIG. 5, the embodiment in FIG. 6 may correspond to a different eye position (e.g., a detected pupil position to the left of that shown in FIG. 5) that the waveguide 420 addresses by activating different subsets of adjustable reflectors. In the embodiment illustrated in FIG. 6, the first subset 428-2 of adjustable reflectors activated in the outcoupler 424 is less than all of the adjustable reflectors 428 associated with the outcoupler 424 of the waveguide illustrated in FIG. 4 and different than the subset 428-1 of adjustable reflectors in the outcoupler 424 that are activated in FIG. 5. Similarly, the second subset 418-2 of adjustable reflectors activated in the exit pupil expander 416 is less than all of the adjustable reflectors 418 associated with the exit pupil expander 416 of the waveguide illustrated in FIG. 4 and different than the subset 418-1 of adjustable reflectors in the exit pupil expander 416 that are activated in FIG. 5. The other adjustable reflectors not included in either of the subsets are deactivated or turned off (i.e., placed in the transparent state). In this manner, the waveguide 420 turns off (deactivates) a subset of the adjustable reflectors in both the exit pupil expander 416 and the outcoupler 424 to support a smaller eyebox that is better tailored to the user's eye pupil distance, pupil position, or type of virtual content that is being presented.

In some embodiments, for a given user, the eyewear display (such as eyewear display 100 of FIG. 1 or eyewear display 300 of FIG. 3) housing the waveguide 420 performs an initial calibration step to measure the IPD of a user and saves the IPD in a memory storing display settings of the eyewear display. A controller (such as controller 250 of FIGS. 2 and 3) of the eyewear display then activates the appropriate adjustable reflectors in the waveguide 420 such that the waveguide 420 outcouples display light to an eyebox corresponding to the saved IPD. In this manner, the eyebox delivered by the waveguide 420 is specifically tailored to account for the user's facial geometry and potential pupil positions (e.g., due to eye movement such as eyeroll). The specially tailored eyebox requires a smaller number of adjustable reflectors to expand light. Therefore, by deactivating or turning off the other adjustable reflectors that are not needed to deliver light to the specifically tailored eyebox, the efficiency of the waveguide 420 and the uniformity of the image delivered to the user is improved. In addition, the generation of ghost and see-through artifacts is reduced or eliminated.

In some embodiments, the eyewear display is configured to adjust the reflectivity of the adjustable reflectors in the waveguide 420. For example, a controller (such as the controller 250 of FIGS. 2 and 3) is configured to apply different voltage control signals to subsets of adjustable reflectors in order to adjust the reflectivity of the adjustable reflectors in each subset. In some cases, the reflectivity is adjusted based on the size of the activated subset of adjustable reflectors. For example, when the eyewear display activates the adjustable reflectors for the entire eyebox or FOV area, the reflectivity of the adjustable reflectors is kept relatively low (e.g., 3-20% reflectivity) in order to minimize the light depletion at the far end of the outcoupler and increase the uniformity across the FOV area and the eyebox. On the other hand, when the activated size of the adjustable reflector array is reduced to support a smaller eyebox or FOV area, the associated light depletion is also reduced, and thus the reflectivity of the adjustable reflectors may be increased to a higher level (e.g., 20-50% reflectivity). Thus, the reflectivity of the adjustable reflectors affects both the efficiency of the waveguide and the uniformity of the display. In certain scenarios, e.g., in a bright light ambient environment, the eyewear display is configured to increase the reflectivity of the adjustable reflectors to improve efficiency while sacrificing uniformity that may not be as noticeable to a user in such a scenario.

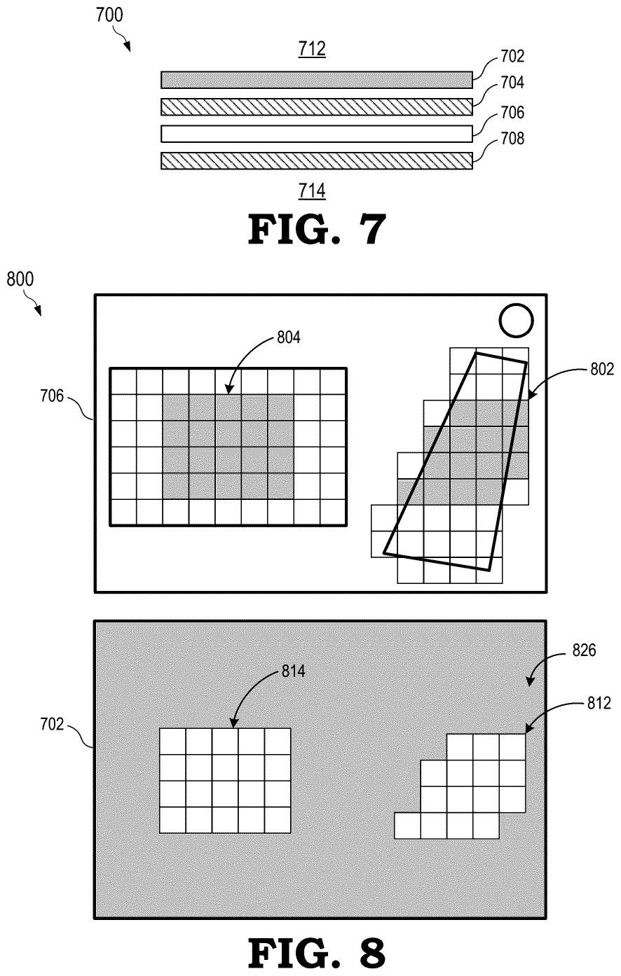

In some cases, adjusting the reflectivity of subsets of the adjustable reflectors can create cosmetic concerns. For example, since switching the reflectivity of a particular subset of adjustable reflectors also affects the transmission of light in the corresponding areas, outside observers may perceive the outline of these areas as they change over time. To mitigate this effect, in some embodiments, the eyewear display also includes a dimming module in the optical combiner along with the waveguide. In this manner, the change in reflectivity of subsets of adjustable reflectors in the waveguide is offset with a change in the transmission of light across different parts of the dimming module so as to reduce the appearance of changes in the lenses to outside observers. An example of the optical combiner components is illustrated in FIG. 7.

FIG. 7 shows a cross section view of an optical combiner stack 700 in accordance with some embodiments. In some embodiments, the optical combiner stack 700 corresponds to the optical combiner lens 304 of FIG. 3. The optical combiner stack 700 includes a dimming module layer 702, a waveguide 706 (such as one corresponding to waveguide 220 of FIGS. 2-3 or waveguide 420 of FIGS. 4-6), and two lenses 704, 708 (such as those corresponding to lenses 306, 308 of FIG. 3). In the illustrated embodiment, the dimming module layer 702 faces the world side 712 and a first lens 708 faces the user side 714. In the illustrated embodiment, the dimming module 702 is shown as being on the world side 712 of the second lens 704. In another embodiment, the dimming module 702 is positioned between the second lens 704 and the waveguide 706. In any case, the dimming module layer 702 includes regions corresponding to the regions (e.g., regions 418 of the exit pupil expander 416 and regions 428 of the outcoupler 424) of the waveguide 706. In some embodiments, the dimming module layer 702 reduces the brightness of the ambient light from the real world to improve the visibility of the virtual content. In some embodiments, the dimming module layer 702 is a photochromic layer that adjusts its transmission based on different light conditions.

FIG. 8 shows plan views of the waveguide 706 and the dimming module layer 702 of FIG. 7 in accordance with some embodiments. In particular, FIG. 8 illustrates how the dimming module layer 702 compensates for the reduced transmission of the regions of the waveguide due to the activation of the adjustable reflectors in the waveguide 706. The waveguide 706 includes sets of adjustable reflectors as described above with respect to FIGS. 4-6. In the illustrated embodiment, the waveguide 706 activates a first subset 802 (indicated by the shaded boxes) of the adjustable reflectors in the exit pupil expander and a second subset 804 (indicated by the shaded boxes) of the adjustable reflectors in the outcoupler. Since the regions of the waveguide 706 associated with the first subset 802 and the second subset 804 of adjustable reflectors have a higher reflectivity, the transmission of light in these regions is reduced. Thus, in order to mitigate the appearance of the activated regions of the waveguide 706 to an outside observer, the dimming module layer 702 increases or decreases the transmission of light in its corresponding areas that overlap with the activated regions of the waveguide 706. For example, area 812 of the dimming module layer 702 corresponds to the region of the first subset 802 of the activated adjustable reflectors in the exit pupil expander of waveguide 706 and area 814 of the dimming module layer 702 corresponds to the region of the second subset 804 of the activated adjustable reflectors in the outcoupler of the waveguide 706. Each of areas 812, 814 of the dimming module layer 702 have higher transmission to compensate for the lower transmission of regions 802, 804 of the waveguide, and the rest 826 (indicated by the shaded area) of the dimming module layer 702 has a decreased transmission to match up with the increased transmission of the other areas of the waveguide 706 not associated with regions 802, 804. In this manner, to an outside observer, the optical combiner stack 700 in a lens of the eyewear display has a more uniform appearance across its area.

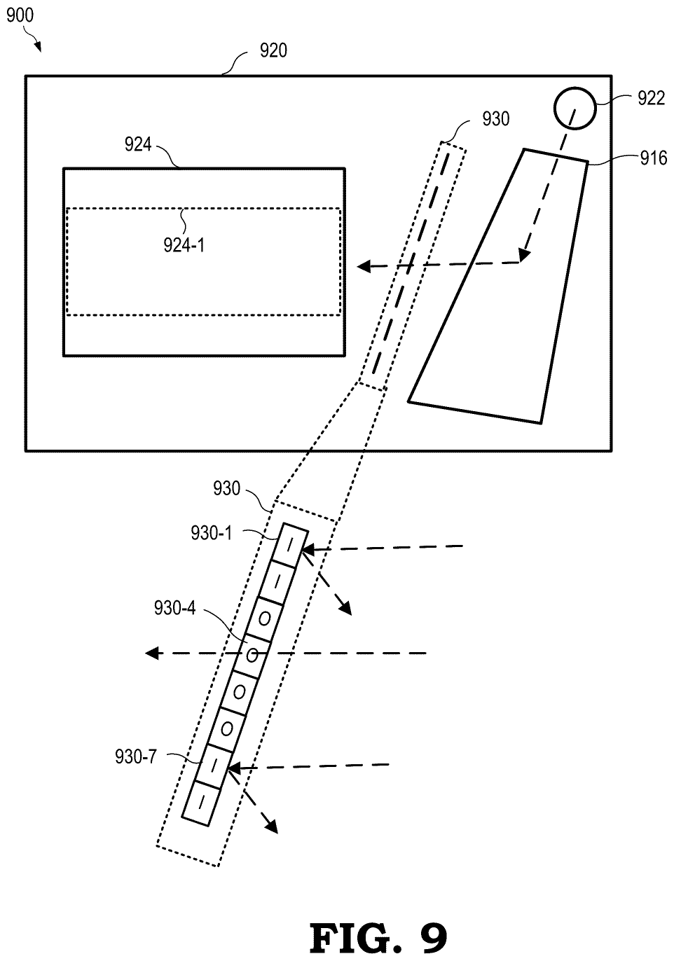

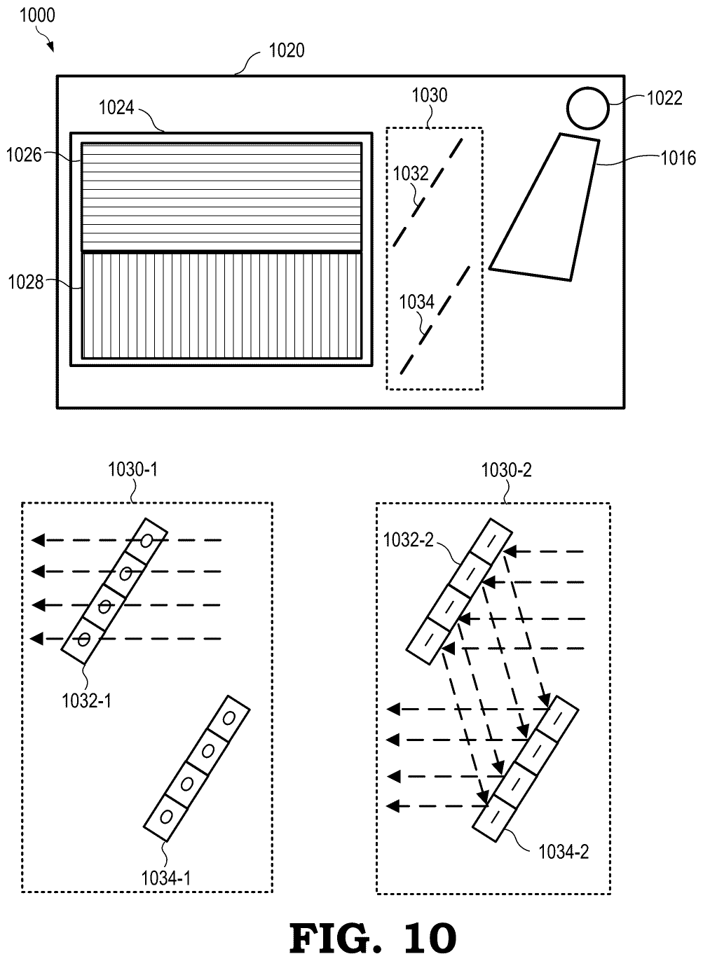

In some embodiments, in addition or in alternative to including adjustable reflectors in the exit pupil expander or the outcoupler, adjustable reflectors are embedded in the waveguide between the exit pupil expander and the outcoupler. For example, in some cases, the outcoupler and exit pupil expander include passive (i.e., non-adjustable) reflective or diffractive elements and the adjustable reflectors are included in a switchable filter that selectively transmits or reflects light from the exit pupil expander to the outcoupler to modify which parts of the outcoupler are activated for outcoupling light to the user. Two such embodiments are shown in FIGS. 9-10.

FIG. 9 shows an embodiment of a switchable filter 930 embedded in a waveguide 920 between the exit pupil expander 916 and the outcoupler 924 in accordance with some embodiments. In some embodiments, the waveguide 920 corresponds to the waveguide 220 of FIGS. 2 and 3.

The waveguide 920 includes an incoupler 922, an exit pupil expander 916, and an outcoupler 924. In the illustrated embodiment, the incoupler 922, the exit pupil expander 916, and the outcoupler 924 are passive (i.e., non-adjustable) reflective or diffractive elements, for example. The waveguide 920 also has a switchable filter 930 composed of multiple segments of adjustable reflectors. The switchable filter 930 is configured to selectively activate and deactivate the adjustable reflectors to filter the light that is propagated from the exit pupil expander 916 to the outcoupler 924. For example, in the illustrated embodiment, the switchable filter 930 includes a single layer of adjustable reflectors 930-1 to 930-8 (only the first adjustable reflector 930-1, the fourth adjustable reflector 930-4, and the seventh adjustable reflector 930-7 are labeled for clarity). Thus, depending on which ones of the adjustable reflectors 930-1 to 930-8 are activated or turned on (marked as “I”) or deactivated or turned off (marked as “O”) by a controller (such as controller 250 of FIG. 2), the switchable filter 930 operates as a selective light barrier between the exit pupil expander 916 and the outcoupler 924. In this manner, the switchable filter 930, in conjunction with the controller, controls which section of the eyebox the outcoupler 924 outcouples light to. In the illustrated embodiment, the first two and the last two adjustable reflectors of the switchable filter 930 are activated (i.e., turned to or left in the “on” state) to reflect light away from the outcoupler 924, and the middle four adjustable reflectors are deactivated (i.e., turned to or left in the “off” state) to allow light from the exit pupil expander 916 to pass through. Thus, the middle portion 924-1 of the outcoupler 924 receives light from the exit pupil expander 916 and outcouples this light to the user. The remaining portion of the coupler 924 outside of 924-1 does not receive light from the exit pupil expander 916, and therefore does not outcouple light to the user. For example, the middle portion 924-1 of the outcoupler 924 may correspond to a user pupil position area (e.g., determined by an eye tracking component such as eye tracking component 260), and thus the middle portion 924-1 of the outcoupler 924 is used to outcouple light so that the user can view virtual content while the remaining part of the outcoupler 924 is not needed. Thus, by selectively filtering which light is propagated to the outcoupler 924, the switchable filter 924 reduces artifacts such as eye-glow and scatter in the non-illuminated regions.

FIG. 10 shows another embodiment of a switchable filter 1030 embedded in a waveguide 1020 between the exit pupil expander 1016 and the outcoupler 1024 in accordance with some embodiments. In some embodiments, the waveguide 1020 corresponds to the waveguide 220 of FIGS. 2 and 3.

The waveguide 1020 includes an incoupler 1022, an exit pupil expander 1016, and an outcoupler 1024. In the illustrated embodiment, the incoupler 1022, the exit pupil expander 1016, and the outcoupler 1024 are passive (i.e., non-adjustable) reflective or diffractive elements, for example. The waveguide 1020 also has a switchable filter 1030 composed of a pair of adjustable reflector segments 1032, 1034. The pair of adjustable reflectors segments 1032, 1034 are configured to selectively re-direct light from the exit pupil expander 1016 to different sections of the outcoupler 1024. In this manner, the exit pupil expander 1016 can be truncated to propagate light directly to a top region 1026 of the outcoupler 1024 while the switchable filter 1030 is configured to adjust which sections of the outcoupler 1024 receive light from the truncated exit pupil expander 1016. For example, referring to a first scenario 1030-1, all of the adjustable reflectors 1032-1 (one labeled for clarity) in the first adjustable reflector segment 1032 are turned off or deactivated (marked by “O”) so that light directly passes through from the exit pupil expander 1016 to the outcoupler 1024. Thus, in this first scenario 1030-1, the switchable filter 1030 operates to selectively direct light to the top region 1026 of the outcoupler 1024. In a second scenario 1030-2, all of the adjustable reflectors 1032-2 (one labeled for clarity) in the first adjustable reflector segment 1032 and all of the adjustable reflectors 1034-2 (one labeled for clarity) in the second adjustable reflector segment 1034 are turned on or activated (marked by “I”). Thus, in this second scenario 1030-2, the switchable filter 1030 operates to selectively direct light to the bottom region 1028 of the outcoupler 1024. In other embodiments, different combinations of the adjustable reflectors in each of the first adjustable reflector segment 1032 and the second adjustable reflector segment 1034 are activated or deactivated to change which region of the outcoupler 1024 receives light. In this manner, the switchable filter 1030 is configured to selectively activate and deactivate the adjustable reflectors in each of the first adjustable reflector segment 1032 and the second adjustable reflector segment 1034 to direct light to a specific region of the outcoupler 1024. That is, depending on which ones of the adjustable reflectors in each of the first adjustable reflector segment 1032 and the second adjustable reflector segment 1034 are activated or turned on (marked as “I”) or deactivated or turned off (marked as “O”) by a controller (such as controller 250 of FIG. 2), the switchable filter 1030 selectively directs light between the exit pupil expander 916 and the outcoupler 924. In this manner, the switchable filter 1030, in conjunction with the controller, controls which section of the eyebox the outcoupler 1024 outcouples light to.

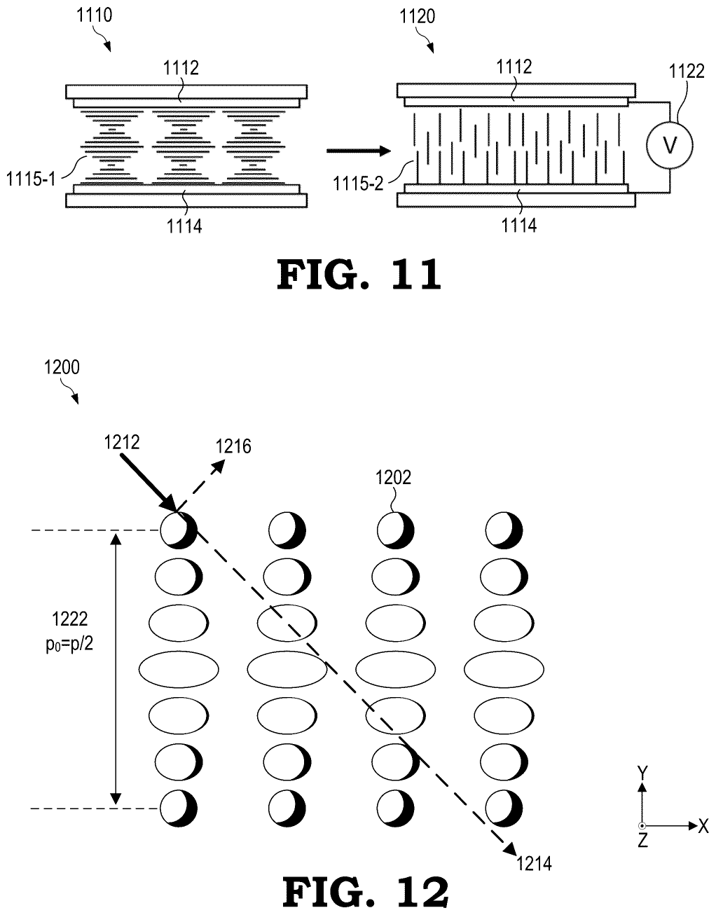

FIG. 11 shows an example of switching an adjustable reflector, such as those described above in FIGS. 1-10, from a first state 1110 to a second state 1120 in accordance with various embodiments. In the illustrated embodiment, the adjustable reflector includes an active liquid crystal layer 1115 arranged between two electrodes 1112, 1114.

The two electrodes 1112, 1114 are transparent conductive electrodes. For example, the two electrodes 1112, 1114 include a transparent conductive film composed of a metal oxide such as indium tin oxide, a wider-spectrum transparent conductive oxide, a conductive polymer, a metal grid, carbon nanotubes, graphene, nanowire meshes, ultra-thin metal films, or the like.

In some embodiments, the active liquid crystal layer 1115 includes cholesteric liquid crystals (CLCs). CLCs are characterized by a helical supramolecular structure caused by chiral molecules. In some cases, the CLCs contain its own chiral molecules (referred to as intrinsic CLCs) and in other cases, the CLCs include a chiral dopant that induces the helical structure in the nematic phase (referred to as induced cholesteric or chiral nematic LCs). Depending on the stereoisomeric form, the chiral molecules are referred to as left-handed or right-handed chiral molecules, which causes twisting of the LC molecules in opposite directions. The pitch length, p, of the formed helix (corresponding to a 360° molecular rotation along the helical axis) depends on the helical twisting power of the chiral dopant, B, and its concentration, c, in the LC, where p=1/(β*c). The structures formed by the CLC depend on anchoring conditions at the bounding substrates. For substrates causing homeotropic (normal to the substrate) alignment, the helix axis is horizontal. When observed through a polarizing microscope, this structure appears as a periodic texture (also referred to as a fingerprint texture) having properties similar to those of a diffraction grating. For substrates causing planar (in the plane of the LC layer) alignment, a planar cholesteric structure with a standing helix known as a Grandjean structure is formed.

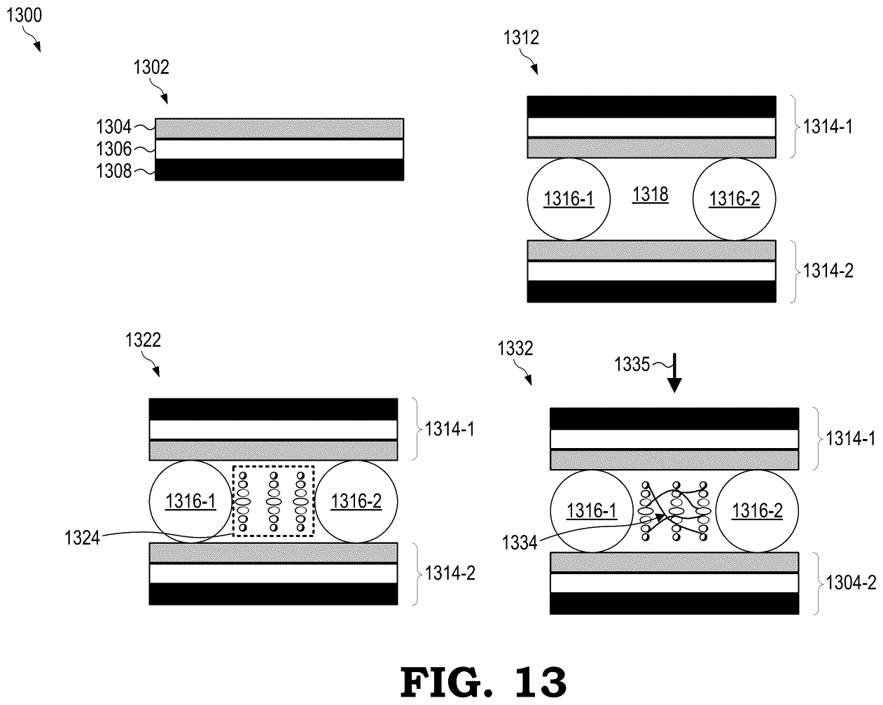

FIG. 12 shows an example of a CLC planar structure 1200 in accordance with some embodiments. The CLC molecules 1202 (one label for clarity) are equally aligned in the z-direction at the substrate-CLC interface. Molecular twisting of the CLC molecules 1202 occurs along the y-direction so that the formed helix is vertically oriented. In the illustrated embodiment, each row of CLC molecules along the y-direction is rotated 30° with respect to the row above and below it. Along with the molecular periodicity, the formed helical structure has an optical periodicity 1222 in the z-direction with the period p₀=p/2, where p is the pitch length of the formed helix. The optical pitch length, p₀, is half the length of the structural (helical) pitch length, p, because the 180° and the 360° rotations of the CLC molecules are optically indistinguishable. In the optical sense, the CLC planar structure 1200 functions as a Bragg grating with the grating fringes parallel to the surface of the CLC layer. As such, the CLC planar structure 1200 functions as a selectively reflective surface that is referred to herein as a CLC reflector or a CLC mirror. Similar to a metal mirror, the CLC reflector causes specular reflection, but in a narrower spectral region. The maximum wavelength of the reflection of the CLC reflector is λₘₐₓ=n*p and the width of the reflection band is Δλ=Δn*p, where n is the average refractive index of the CLC and Δn=nₑ−nₒ is the birefringence, where nₑ and nₒ are the extraordinary and ordinary refractive indices of the CLC, respectively.

In addition, the CLC reflector illustrated in FIG. 12 has several distinctive features, one of which is its polarization sensitivity. For incident unpolarized light 1212, a light component 1216 of one circular polarization is reflected while the other light component 1214 with orthogonal circular polarization passes through the CLC reflector unchanged. For example, a planar cholesteric structure with right-handed helical twisting reflects light of right-handed polarization and transmits light of left-handed polarization. Similarly, a planar cholesteric structure with left-handed helical twisting reflects light of left-handed polarization and transmits light of right-handed polarization. As such, a single CLC reflector layer such as that shown in FIG. 12 acts as a semi-transparent polarization sensitive mirror. In some embodiments, to reflect light of both polarizations (i.e., left-handed and right-handed circular polarizations), a layer of right-handed CLCs is stacked with a layer of left-handed CLCs. In any case, the CLC reflector described above can be either passive or active (i.e., adjustable).

Referring back to FIG. 11, the active liquid crystal layer 1115 is, in some embodiments, composed of active CLCs (such as those of FIG. 12) that are orientally responsive to an electric field. The dielectric anisotropy of these active CLCs is generally positive (Δε>0). As such, the active CLCs re-orient themselves parallel to an applied electric field. In the case of a planar cholesteric structure of active CLCs, this re-orientation results in deformation of the helical structure, thereby resulting in unwinding of the helical structure at a voltage, V, greater than a threshold voltage, V_{CN}. In some cases, the threshold voltage, V_{CN}, is associated with the transition of the active CLCs from the cholesteric phase (i.e., having a helical structure) to the nematic phase (i.e., having an unwound structure), and thus corresponds to a transition from a reflective state to a transmissive or transparent state. In FIG. 11, the first state 1110 corresponds to the reflective state in which the active CLCs 1115-1 exhibit a helical structure, and the second state 1120 corresponds to the transparent state in which the active CLCs 1115-2 are unwound due to the application of a voltage, V, 1122 to the electrodes 1112, 1114, where the voltage, V, 1122 is greater than the threshold voltage, V_{CN}, of the active CLCs 1115. The dependence of reflection (or transmission) of the active CLCs 1115 on the voltage is sharp, but intermediate (i.e., semi-reflective) states are also obtainable. The switching from the first state 1110 to the second state 1120 is a forced (voltage induced) structural transition which is relatively fast in the order of tens of milliseconds (ms). The switching from the second state 1120 back to the first state 1110 is a structural relaxation after the voltage, V, 1122 is removed. In some cases, this may be relatively slow ranging from hundreds of ms to several seconds. In some embodiments, in order to accelerate switching in both directions between the first state 1110 and the second state 1120, the active CLCs 1115 includes a dual-frequency active CLC mixture. The dual-frequency active CLC mixture have positive Δε at low frequencies (f<f_{cross}) and negative Δε at high frequencies (f>f_{cross}), where f_{cross} is a crossover frequency at which Δε=0. At room temperature, f_{cross} is of the order of 1 kHz, but its value is generally temperature-dependent. Using this type of dual-frequency active CLC mixture, switching from the first state 1110 to the second state 1120 is implemented with a low-frequency voltage, and switching from the second state 1120 to the first state 1110 is implemented with a high-frequency voltage. With this approach, switching from the second state 1120 to the first state 1110 can be performed in tens or hundreds of milliseconds.

In some embodiments, the planar helical structure shown in the first state 1110 or in FIG. 12 may contain manufacturing defects, which may expand or increase in the process of switching between states due to the applied electric field. These defects deteriorate the optical uniformity of the active CLC layer in the adjustable reflector. In order to minimize these defects, the manufacturing process can include special treatment of the alignment substrates, optimization of the active CLC mixture, and optimized filling conditions. To prevent deterioration of the active CLCs due to switching between the states due to the electric field induced by the applied voltage, the active CLC layer includes a polymer network in some embodiments. The polymer network serves to stabilize the active CLCs, and, in some embodiments, also serves to accelerate the switching from the second state 1120 to the first state 1110. In addition, the polymer network may broaden the reflection band via forming a gradient of helical pitch. As such, in some embodiments, the active CLCs (such as the active CLCs 1115 of FIG. 11) in the adjustable reflectors are doped with other additives that contribute to the formation of the desired structure and electro-optical performance.

FIG. 13 shows a method 1300 of fabricating an adjustable reflector, such as one described in FIGS. 1-11, in accordance with some embodiments.

In the first step 1302, the method 1300 includes assembling a stack with a substrate 1308, a transparent conductive electrode 1306, and an alignment layer 1304. The substrate 1308 is a transparent material such as a glass or plastic. In some embodiments, the substrate 1308 has a thickness of about 100 to 900 micrometers (μm). The transparent conductive electrode 1306 is an inorganic or organic transparent conductive layer. For example, the transparent conductive electrode 1306 is an indium tin oxide layer or a PEDOT:PSS polymer layer. In some embodiments, the transparent conductive electrode 1306 has a thickness in the range of 10-100 nanometers (nm). In some embodiments, the specified surface resistance of the substrate 1308 and the transparent conductive electrode 1306 is in the range of 10 ohms/square to 100 ohms/square. In addition, the refractive index of the transparent conductive electrode 1306 closely matches the refractive index of the substrate 1308 and the surrounding medium to prevent stray reflections. In some cases, an index matching layer (not shown) is deposited between the transparent conductive electrode 1306 and the substrate 1308 to minimize unwanted reflections from the interface between the conductive electrode 1306 and the substrate 1308 which can be a source of visual artifacts such as ghost images. In some embodiments, the transparent conductive electrode 1306 is a continuous electrode, and in other embodiments, the transparent conductive electrode 1306 is a pixelated electrode. In the latter case, the pixels are driven directly or using a passive or active matrix principle similar to the one used in liquid crystal displays (LCDs).

The transparent conductive electrode 1306 and the substrate 1308 are cleaned and then coated with an organic or inorganic alignment layer 1304 to provide planar or low pre-tilt liquid crystal alignment. In some cases, the alignment layer 1304 is subject to alignment treatment to provide uniform and non-defective liquid crystal alignment. For example, alignment treatment processes include unidirectional rubbing (e.g., of polyimide layers), photoalignment (e.g., for particular photosensitive polymers and dyes), oblique ion/plasma beam etching, oblique sputtering or vapor deposition (e.g., for silicon oxide layers), or the like. In some cases, for flat liquid crystal cells, unidirectional rubbing of rubbed polyimide layers is utilized.

At step 1312, the method 1300 includes assembling the liquid crystal cells. The liquid crystal cell assembled in this step will then be filled with the active liquid crystal (LC) material to create the adjustable reflectors. Two of the stacks 1314-1, 1314-2 formed at step 1302 are assembled on top of one another and separated by spacers 1316-1, 1316-2 to create a gap 1318 that will eventually be filled by the active LC layer in the next step (i.e., step 1322). In the illustrated embodiment, the spacers 1316 are calibrated spherical or cylindrical spacers. In some embodiments, the spacers 1316 are made of silica, polymethyl methacrylate, or the like. The average diameter of the spacers 1316 is selected to set the thickness of the active LC layer. In some embodiments, the spacers 1316 have a diameter in the range of 10 to 100 micrometers.

The method includes positioning the spacers 1316 between the two stacks 1314-1, 1314-2 to create the gap 1318 by one of numerous different techniques. In a first example, the spacers 1316 are set on one of the two stacks 1314-1, 1314-2 prior to positioning the other one of the stacks 1314-1, 1314-2 thereon by using a spacer deposition tool or by printing. In another example, the spacers 1316 are printed on one of the two stacks 1314-1, 1314-2 as a mixture with an optical adhesive (e.g., an ultraviolet (UV) curable optical adhesive). The optical adhesive also serves to fix and seal the assembled LC cell. The concentration of the spacers 1316 in the spacer and optical adhesive mixture is selected to minimize or eliminate aggregation that may potentially result in the liquid crystal cell thickness (i.e., the height of gap 1318) to be different than the target thickness. An adhesive dispensing system, such as a pneumatic controlled dispensing system, locally applies (e.g., via printing) the dosed amount of the spacer and optical adhesive mixture to the edge of one of the stacks 1314-1, 1314-2. The adhesive dispensing system controls the location and distribution of the spacer and optical adhesive mixture pattern in order to minimize or eliminate interference with the active area of the liquid crystal cell. After applying the spacer and optical adhesive mixture to one of the stacks 1314-1, 1314-2, the second one of the stacks 1314-1, 1314-2 is placed on the other side of the spacer 1316 and optical adhesive mixture pattern to form the liquid crystal cell illustrated at step 1312. Then, step 1312 includes applying uniform pressure to set the correct cell thickness (i.e., height of the gap 1318), which can be actively monitored using a Fabry-Penot interferometer. Finally, the optical adhesive is cured (e.g., by UV or other means) to set the liquid crystal cell including the two stacks 1314 with the spacers 1316 arranged therebetween.

At step 1322, the method 1300 includes filling the gap 1318 of the liquid crystal cell of step 1312 with an active LC material 1324 to create the adjustable reflector.

In some embodiments, the active LC material 1324 includes an active CLC such as the one described above in FIGS. 11 and 12. For example, the active CLC is a nematic LC with a chiral dopant (induced cholesteric) and the reflection band of the active CLC at least partially covers the visible light range. In some embodiments, the active CLC has a positive dielectric anisotropy (i.e., Δε>0), and in other embodiments, the active CLC has a Δε that changes with the frequency of an applied electric field (e.g., a dual-frequency LC).

In some embodiments, the filling of the gap 1318 with the active LC material 1324 includes adding a photocurable pre-polymeric composition along with the active LC material. The photocurable pre-polymeric composition has pre-polymers (monomers or oligomers) that are mesogenic, non-mesogenic, or mixtures thereof. In some embodiments, the concentration of the pre-polymer composition relative to the active LC material 1324 is about 5% or less. The pre-polymer composition includes a small amount (e.g., less than about 0.5%) of photoinitiator to initiate polymerization under suitable conditions (e.g., under UV irradiation). In some embodiments, in addition to the photocurable pre-polymeric composition, the active LC material 1324 is also doped with other additives to contribute to the formation of a particular LC structure having particular electro-optical characteristics.

In some embodiments, the filling of the gap 1318 with the active LC material 1324 is performed in a vacuum chamber to reduce the possibility of voids or air bubbles inside the active area (i.e., inside the active LC material 1324). Additionally, in some cases, the filling of the gap 1318 with the active LC material 1324 is done at elevated temperatures to improve the alignment quality of the active LC material. In a vacuum, the active LC material 1324 will fill the gap 1318 due to capillary force. Once filled, the temperature can be slowly ramped down to ensure proper LC alignment. Then, the holes used to inject the active LC material 1324 into the gap 1318 are filled with an optically suitable filler to create the adjustable reflector.

In case the active LC material 1324 added at step 1322 includes the photocurable pre-polymeric composition, the method 1300 includes an additional curing step 1332 to polymerize the photocurable pre-polymeric composition. In the illustrated embodiment, this curing step 1332 includes exposing the adjustable reflector to UV light 1335 to create a polymer network 1334 in the active area (i.e., the area filled with the active LC material 1324) of the adjustable reflector. The polymer network 1334 serves to stabilize the active LC material in the adjustable reflector and may also modify electro-optical performance of the adjustable reflector to a particular characteristic (e.g., to a particular response to an applied electric field).

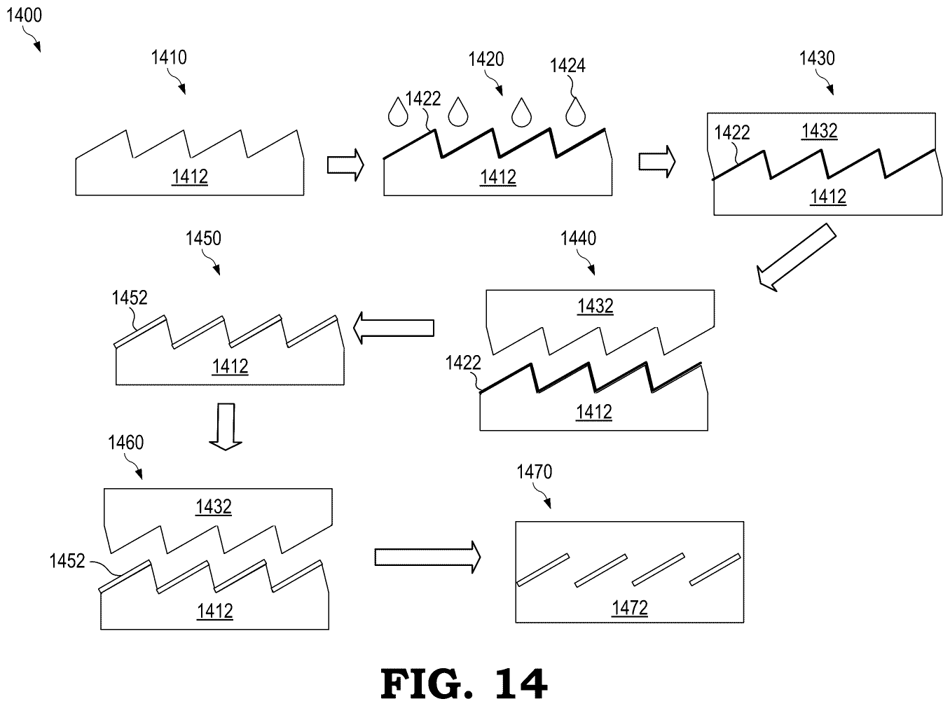

FIG. 14 shows a first fabrication process 1400 for forming a reflective waveguide with adjustable reflectors in accordance with some embodiments. At step 1410, the method includes casting the first part 1412 of the waveguide with a glass, polymer, plastic, or other optically transparent material. At step 1420, the method includes applying an anti-sticking layer 1422 to the first part 1412 of the waveguide and casting a polymer 1424 on top of the anti-sticking layer 1422 to form the second part of the waveguide 1432 at step 1430. At step 1440, the method includes separating the first part 1412 of the waveguide from the second part 1432 of the waveguide and removing the anti-sticking layer 1422.

At step 1450, the method includes laminating the adjustable reflectors 1452 (one labeled for clarity) on the first part 1412 of the waveguide. The adjustable reflectors 1452, for example, correspond to the adjustable reflectors fabricated by the process of FIG. 13. An optically-suitable, refractive index matching adhesive is used to adhere the adjustable reflectors 1452 to the first part 1412 of the waveguide. In some embodiments, to reflect all unpolarized light, each adjustable reflector 1452 includes a laminated stack of multiple adjustable reflectors that have the same reflection bands but are each sensitive to different, mutually orthogonal circular polarizations. Then, at step 1460, the second part 1432 of the waveguide is re-assembled over the adjustable reflectors 1452 and fixed thereto with an index matching adhesive applied to the entire contact surface to produce the reflective waveguide with adjustable reflectors 1472 at the final step 1470.

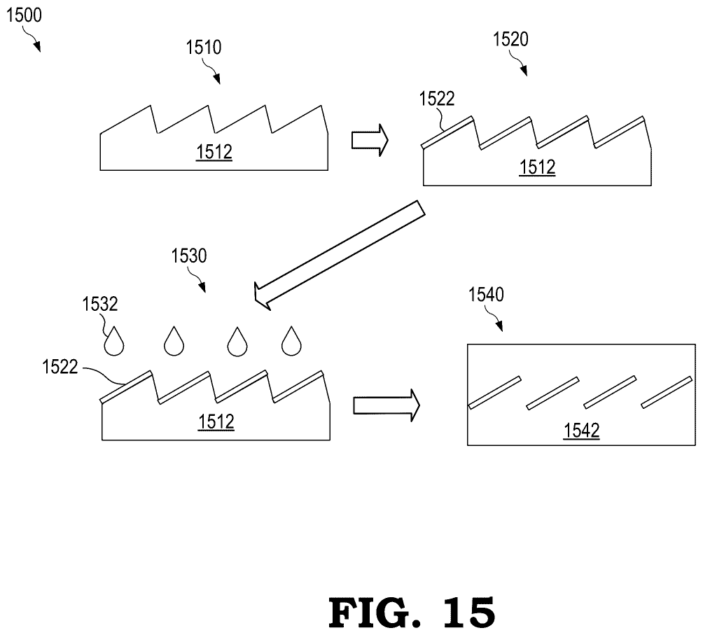

FIG. 15 shows a second fabrication process 1500 for forming a reflective waveguide with adjustable reflectors in accordance with some embodiments. At step 1510, the method includes casting the first part 1512 of the waveguide with a glass, polymer, plastic, or other optically transparent material. At step 1520, the method includes laminating the adjustable reflectors 1522 (one labeled for clarity) on the first part 1512 of the waveguide. The adjustable reflectors 1522, for example, correspond to the adjustable reflectors fabricated by the process of FIG. 13. An optically-suitable, refractive index matching adhesive is used to adhere the adjustable reflectors 1522 to the first part 1512 of the waveguide. In some embodiments, to reflect all unpolarized light, each adjustable reflector 1522 includes a laminated stack of multiple adjustable reflectors that have the same reflection bands but are each sensitive to different, mutually orthogonal circular polarizations. At step 1530, the method includes casting a polymer or plastic material 1532 on top of the first part 1512 of the waveguide with the adjustable reflector 1522 to form the reflective waveguide with adjustable reflectors 1542 at the final step 1540.

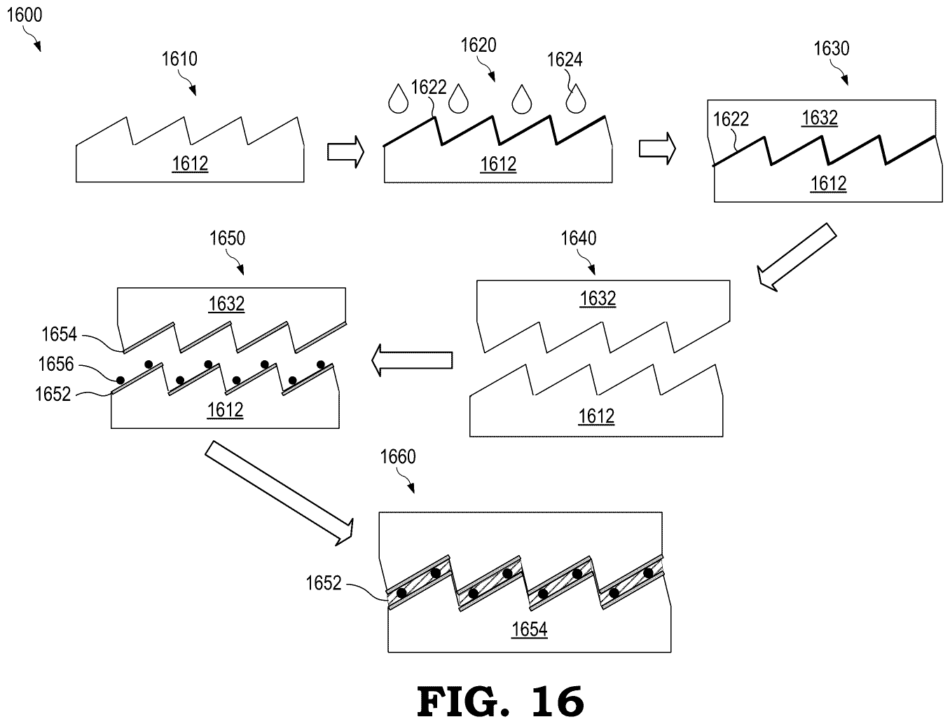

FIG. 16 shows a third fabrication process 1600 for forming a reflective waveguide with adjustable reflectors in accordance with some embodiments. At step 1610, the method includes casting the first part 1612 of the waveguide with a glass, polymer, plastic, or other optically transparent material. At step 1620, the method includes applying an anti-sticking layer 1622 to the first part 1612 of the waveguide and casting a polymer 1624 on top of the anti-sticking layer 1622 to form the second part of the waveguide 1632 at step 1630. At step 1640, the method includes separating the first part 1612 of the waveguide from the second part 1632 of the waveguide and removing the anti-sticking layer 1622. At step 1650, the method includes applying a first electrode and alignment layer 1652 (one instance labeled for clarity) to the first part 1612 of the waveguide and a second electrode and alignment layer 1654 (one instance labeled for clarity) to the second part 1632 of the waveguide. In some embodiments, each one of the first and second electrode and alignment layers 1652, 1654 include components corresponding to the transparent conductive electrode 1306 and the alignment layer 1304 of FIG. 13. In some embodiments, each one of the transparent conductive electrode and the alignment layers of the first and second electrode and alignment layers 1652, 1654 are applied via a conformal deposition process such as vapor or sputtering deposition, dip coating, slot coating, spray coating, or the like. In addition, spacers 1656 (one labeled for clarity) similar to the spacers 1316 of FIG. 13 are deposited on one of the first or the second electrode and alignment layers 1652, 1654. Then, the first part 1612 of the waveguide with the first electrode and alignment layer 1652 and the second part 1632 of the waveguide with the second electrode and alignment layer 1654 are adhered to one another with an optical adhesive with the spacers 1656 providing a spacing therebetween. At step 1660, the method includes filling the spacing with an active LC material 1652 such as the active LC materials described above, e.g., the active LC materials of FIGS. 11-13 and optionally curing the active LC material 1652 to form the reflective waveguide with adjustable reflectors 1654.

The reflective waveguide with adjustable reflectors produced by any one of the methods described in FIGS. 13-16 is then incorporated into an optical combiner lens of an eyewear display. For example, any one of the reflective waveguides with adjustable reflectors 1472, 1542, 1654 is used as the waveguide 220 in the optical combiner lens 304 of the eyewear display 300 of FIG. 3. In addition, the reflective waveguide with adjustable reflectors is connected to a controller, such as controller 250 of FIGS. 2 and 3, such that the controller can provide voltage control signals to switch the states of the adjustable reflectors in the reflective waveguide with adjustable reflectors.

In some embodiments, the amplitude and the shape of voltage control signal from the controller depends on the type of active LC material (e.g., single frequency or dual frequency LC) used in the adjustable reflectors, the presence of a polymer network in the adjustable reflectors, and the kind of matrix used in the case of a pixelated electrode. For example, in the case of pixelated electrodes, the pixels are driven directly or using a passive or active matrix principle as used in LCDs.

A controller (such as controller 250 of FIGS. 2 and 3) is configured to drive the adjustable reflectors with active CLCs having an Δε>0 according to the following scheme. To achieve a particular level of reflection, the controller applies an alternating voltage pulse (e.g., 50 Hz to few kHz) of suitable amplitude for a few seconds. To change the reflectivity, the controller applies a refreshing pulse of higher voltage and the same frequency to return the active CLC material back to it original planar state.

In another example, a controller (such as controller 250 of FIGS. 2 and 3) is configured to drive the adjustable reflectors with dual-frequency active CLCs according to the following scheme. The controller applies a low-frequency voltage (e.g., f=50-300 Hz) to transfer the CLC from a flat state to a homeotropic state (i.e., from a reflective (or partially reflective) state to a transmissive state). The controller applies a high-frequency voltage (e.g., tens of kHz) to switch the adjustable reflector in the opposite direction (i.e., from a transmissive state to a reflective (or partially reflective) state).

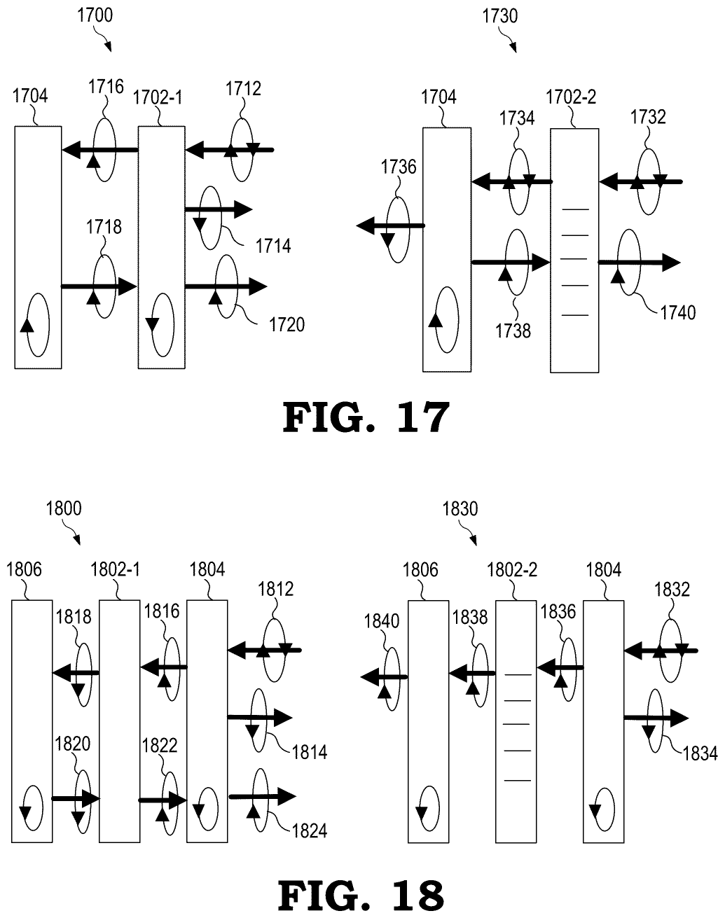

In some embodiments, the adjustable reflectors in the waveguide also include passive elements. For example, the adjustable reflector includes a passive mirror composed of passive LCs (also referred to as polymerizable LCs or reaction mesogens). These materials contain one or more polymerizable groups which fix the orientation structure after photopolymerization. A layer with these materials is thus solidified after polymerization so that another LC layer can be formed on top of it. Accordingly, in some embodiments, the adjustable reflectors in the waveguide include a combination of passive layers and active CLC layers as well as other switchable optical components (e.g., half- or quarter-wave plates). FIGS. 17 and 18 illustrate two such examples.

FIG. 17 shows a first example of an adjustable reflector with one or more passive elements in accordance with some embodiments. The adjustable reflector includes a passive CLC layer 1704 stacked with an active CLC layer 1702. The left diagram 1700 of FIG. 17 shows the passive CLC layer 1704 and the active CLC layer 1702 in an off state, i.e., off state active CLC layer 1702-1. The right diagram 1730 of FIG. 17 shows the passive CLC layer 1704 and the active CLC layer 1702 in the on state, i.e., on state active CLC layer 1702-2.

Referring first to the left diagram 1700, a controller (such as controller 250 of FIGS. 2 and 3, not shown in FIG. 17) does not apply a voltage to the active CLC layer 1702 so that the active CLC layer 1702 is in the off state 1702-1. In the illustrated embodiment, the off state active CLC layer 1702-1 reflects light having a first polarization state (in this example, a left-handed polarization state corresponding to a counterclockwise rotation). The passive CLC layer 1704 reflects light having a second polarization state (in this example, a right-handed polarization state corresponding to a clockwise rotation). In this manner, the combination of the passive CLC layer 1704 and the off state active CLC layer 1702-1 reflects all of the unpolarized light 1712 incident thereon.

To illustrate, the off state active CLC layer 1702-1 reflects the left-handed polarization state component 1714 of the incident light 1712 while the right-handed polarization state component 1716 of the incident light 1712 passes through the off state CLC layer 1702-1. The passive CLC layer 1704 then reflects the right-handed polarization state component 1716 as reflected right-handed polarization state light 1718, which passes through the off state active CLC layer 1702-1 as reflected right-handed polarization state light 1720. Thus, the adjustable reflector having the passive CLC layer 1704 and off state active CLC layer 1702-1 reflects about 100% of the light incident thereon.

Referring to the right diagram 1730, a controller (such as controller 250 of FIGS. 2 and 3, not shown in FIG. 17) applies a voltage to the active CLC layer 1702. Accordingly, the active CLC layer 1702 is in the on state 1702-2. In the illustrated embodiment, the on state active CLC layer 1702-2 is transparent to light of both polarization states (i.e., right-handed and left-handed polarizations). In this manner, the combination of the passive CLC layer 1704 and the on state active CLC layer 1702-2 reflects about 50% of the unpolarized light 1732 incident thereon.

To illustrate, the on state active CLC layer 1702-2 transmits all of the unpolarized light 1732 as unpolarized light 1734. The passive CLC layer 1704 then reflects the right-handed polarization state component 1738 of the light 1734, while the left-handed polarization state component 1736 passes through the passive CLC layer 1704. The reflected right-handed polarization state component 1738 also passes through the on state active CLC layer 1702-2. Thus, the adjustable reflector having the passive CLC layer 1704 and on state active CLC layer 1702-2 reflects about 50% of the light incident thereon. In this manner, by applying a voltage to the active CLC layer 1702, a controller (not shown) is able to switch the active CLC layer 1702 between an off state and on state such that the reflectivity of the adjustable reflector transitions between 100% reflectivity and 50% reflectivity.

FIG. 18 shows a second example of an adjustable reflector with one or more passive elements in accordance with some embodiments. The adjustable reflector includes two passive CLC layers 1804, 1806 that reflect light having the same polarization state (in this example, a left-handed polarization state corresponding to a counterclockwise rotation) with a switchable fractional wave plate, such as a switchable half-wave plate 1802, placed therebetween. The left diagram 1800 of FIG. 18 shows the switchable half-wave plate 1802 in an off state, i.e., off state switchable half-wave plate 1802-1. The right diagram 1830 of FIG. 18 shows the switchable half-wave plate 1802 in an on state, i.e., on state switchable half-wave plate 1802-1.

Referring first to the left diagram 1800, a controller (such as controller 250 of FIGS. 2 and 3, not shown in FIG. 18) does not apply a voltage to the switchable half-wave plate 1802. Accordingly, the switchable half-wave plate 1802 is in the off state 1802-1. In the illustrated embodiment, the off state switchable half-wave plate 1802-1 converts light having one polarization state (e.g., right-handed polarization) to another polarization state (e.g., left-handed polarization) or vice versa. The passive CLC layers 1804, 1806 reflect light having a second polarization state (in this example, a left-handed polarization state corresponding to a counterclockwise rotation). In this manner, the combination of the passive CLC layers 1804, 1806 and the off state switchable half-wave plate 1802-1 reflects all of the unpolarized light 1812 incident thereon.

To illustrate, unpolarized light 1812 is first incident on the first passive CLC layer 1804, which reflects the left-handed polarization state component 1814 and allows the right-handed polarization state component 1816 to pass through. The off state switchable half-wave plate 1802-1 converted the right-handed polarization state component 1816 to a left-handed polarization state component 1818. This left-handed polarization state component 1818 is reflected by the second passive CLC layer 1806 as reflected left-handed polarization state component 1820. The off state switchable half-wave plate 1802-1 then converts this light back to right-handed polarization state light 1822, which passes through the first passive CLC layer 1804 as right-handed polarization state light 1824. Thus, the adjustable reflector having the passive CLC layers 1804, 1806 and the off state switchable half-wave plate 1802-1 reflects about 100% of the unpolarized light incident thereon.

Referring to the right diagram 1830, a controller (such as controller 250 of FIGS. 2 and 3, not shown in FIG. 17) applies a voltage to switchable half-wave plate 1802. Accordingly, the switchable half-wave plate 1802 is in the on state 1802-2. In the illustrated embodiment, the on state switchable half-wave plate 1802 does not convert the polarization state of light incident thereon. In this manner, the combination of the passive CLC layers 1804, 1806 and the on state switchable half-wave plate 1802-2 reflects about 50% of the unpolarized light 1832 incident thereon.

To illustrate, unpolarized light 1832 is first incident on the first passive CLC layer 1804, which reflects the left-handed polarization state component 1834 and allows the right-handed polarization state component 1836 to pass through. The right-handed polarization state component 1836 passes through the on state switchable half-wave plate 1802-2 unaffected as right-handed polarization state light 1838. Since the second passive CLC layer 1806 also is configured to reflect light having the left-handed polarization state similar to the first passive CLC layer 1804, the right-handed polarization state light 1838 also passes through the second passive CLC layer 1806. Thus, the adjustable reflector having the passive CLC layers 1804, 1806 and the on state switchable half-wave plate 1802-2 reflects about 50% of the unpolarized light incident thereon. And, since the switchable half-wave plate 1802-2 is a nematic or ferroelectric LC element, it can be switched faster than the switchable active CLC layer 1702 shown in FIG. 17. In some embodiments, intermediate values of reflection shown in FIG. 18 (e.g., between 50% and 100% reflectivity) are obtained by changing the duty cycle of the driving signal to the switchable half-plate 1802.

Although not illustrated in FIGS. 17 and 18, in other embodiments, the adjustable reflector additionally or alternatively includes a switchable quarter-wave plate, semi-reflective mirrors, or the like. In some embodiments, the adjustable reflectors with passive and active components described in FIGS. 17 and 18 are manufactured according to any one of the techniques described herein.

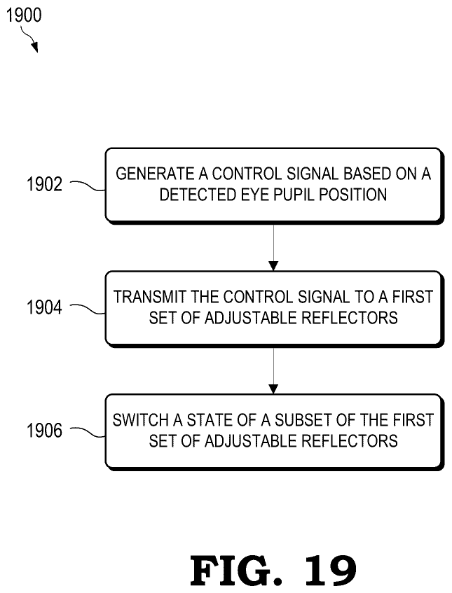

FIG. 19 shows an example of a flowchart 1900 describing a method to adjust the reflectivity of adjustable reflectors in a reflective waveguide of an eyewear display in accordance with some embodiments. At 1902, the method includes, at a controller, generating a control signal based on a detected pupil position. For example, in some embodiments, the pupil position is detected by an eye tracking system or component. At 1904, the method includes the controller transmitting a control signal to a first set of adjustable reflectors in the waveguide. At 1906, the method includes switching a state of a subset of the first set of adjustable reflectors based on the control signal. For example, this includes changing a state of the subset from a reflective state (or partially reflective state) to a transparent state or vice versa. In this manner, the eyewear display is able to modify the eyebox within which the viewer is able to view virtual content generated by the eyewear display.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An eyewear display comprising:
a waveguide comprising a first set of adjustable reflectors, wherein each adjustable reflector of the first set of adjustable reflectors is switchable between a first state in which the adjustable reflector is transparent and a second state in which the adjustable reflector reflects a portion of light incident thereon; and
a controller configured to send a control signal to a subset of the first set of adjustable reflectors to control the subset of the first set of adjustable reflectors to operate in the first state or the second state.

2. The eyewear display of claim 1, wherein the first set of adjustable reflectors is located in an exit pupil expander or an outcoupler of the waveguide.

3. The eyewear display of claim 1, wherein control signal is based on a type of content generated for display by the eyewear display.

4. The eyewear display of claim 1, wherein:
the waveguide comprises a second set of adjustable reflectors, wherein each adjustable reflector of the second set of adjustable reflectors is switchable between a first state in which the adjustable reflector is transparent and a second state in which the adjustable reflector reflects a portion of light incident thereon; and
the controller is configured to send a second control signal to a subset of the second set of adjustable reflectors to control the subset of the second set of adjustable reflectors to operate in the first state or the second state.

5. The eyewear display of claim 4, wherein the first set of adjustable reflectors is located in an exit pupil expander of the waveguide and the second set of adjustable reflectors is located in an outcoupler of the waveguide.

6. The eyewear display of claim 1, wherein the first set of adjustable reflectors is located between an exit pupil expander and an outcoupler of the waveguide.

7. The eyewear display of claim 6, wherein:
the waveguide comprises a second set of adjustable reflectors arranged adjacent to the first set of adjustable reflectors between the exit pupil expander and the outcoupler, wherein each adjustable reflector of the second set of adjustable reflectors is switchable between a first state in which the adjustable reflector is transparent and a second state in which the adjustable reflector reflects a portion of light incident thereon based on a second control signal; and
the controller configured to send the second control signal to a subset of the second set of adjustable reflectors to control the subset of the second set of adjustable reflectors to operate in the first state or the second state.

8. The eyewear display of claim 1, further comprising:
an eye tracking system to determine at least one of a position or an orientation of an eye of a user of the eyewear display; and
the controller configured to send the control signal based on the at least one of the position or the orientation of the eye.

9. The eyewear display of claim 8, wherein the subset of adjustable reflectors is operated in the second state to reflect light toward a pupil position based on the at least one of the position or the orientation of the eye.

10. The eyewear display of claim 1, wherein the controller is configured to generate the control signal based on an interpupillary distance of a user of the eyewear display.

11. The eyewear display of claim 1, wherein each adjustable reflector in the first set of adjustable reflectors comprises a cholesteric liquid crystal layer, wherein the control signal comprises a voltage that modifies an orientation of cholesteric liquid crystals in the cholesteric liquid crystal layer, wherein the first state and the second state are dependent on the orientation of cholesteric liquid crystals in the cholesteric liquid crystal layer.

12. The eyewear display of claim 11, wherein each adjustable reflector in the first set of adjustable reflectors comprises a passive cholesteric liquid crystal layer configured to reflect light having a first polarization state and transmit light having a second polarization state different than the first polarization state.

13. The eyewear display of claim 1, wherein each adjustable reflector in the first set of adjustable reflectors comprises a switchable fractional waveplate, wherein the control signal comprises a voltage that modifies an orientation of switchable fractional waveplate, wherein the first state and the second state are dependent on the orientation of the switchable fractional waveplate.

14. The eyewear display of claim 13, wherein each adjustable reflector in the first set of adjustable reflectors comprises a passive cholesteric liquid crystal layer configured to reflect light having a first polarization state and transmit light having a second polarization state different than the first polarization state.

15. The eyewear display of claim 1, further comprising a dimming module layer positioned at a world side of the waveguide, wherein the dimming module layer comprises regions whose transparency is adjusted based on the subset of the first set of adjustable reflectors operating in the first state or the second state.

16. The eyewear display of claim 1, wherein the portion of light reflected by the adjustable reflectors in the second state is adjustable.

17. A method for controlling display light in an eyewear display, the method comprising:
sending, from a controller of the eyewear display, a control signal to a subset of a first set of adjustable reflectors in a waveguide of the eyewear display; and
switching, for each adjustable reflector in the subset of the first set of adjustable reflectors, between a first state in which the adjustable reflector is transparent and a second state in which the adjustable reflector reflects a portion of display light incident thereon.

18. The method of claim 17, further comprising:
determining, at an eye tracking system of the eyewear display, at least one of a position or an orientation of an eye of a user of the eyewear display; and
generating, at the controller, the control signal based on the at least one of the position or the orientation of the eye.

19. The method of claim 17, the method further comprising:
sending, from the controller, a second control signal to a subset of a second set of adjustable reflectors in a waveguide of the eyewear display; and
switching, for each adjustable reflector in the subset of the second set of adjustable reflectors, between a first state in which the adjustable reflector is transparent and a second state in which the adjustable reflector reflects a portion of display light incident thereon.

20. A waveguide comprising:
a first set of adjustable reflectors, wherein each adjustable reflector of the first set of adjustable reflectors is switchable between a first state in which the adjustable reflector is transparent and a second state in which the adjustable reflector reflects a portion of light incident thereon.

21. The waveguide of claim 20, wherein the first set of adjustable reflectors is located in an exit pupil expander or an outcoupler of the waveguide.

22. The waveguide of claim 20, wherein the first set of adjustable reflectors is located between an exit pupil expander or an outcoupler of the waveguide.

23. The waveguide of claim 20, further comprising:
a second set of adjustable reflectors, wherein each adjustable reflector of the second set of adjustable reflectors is switchable between a first state in which the adjustable reflector is transparent and a second state in which the adjustable reflector reflects a portion of light incident thereon.
